(19) United States
(12) Patent Application Publication
(10) Pub. No.: US 2022/0330064 A1
(43) Pub. Date: Oct. 13, 2022

(54) METHOD AND DEVICE IN NODES USED FOR WIRELESS COMMUNICATION

(71) Applicants: Zheng LIU, SHANGHAI (CN); Xiaobo ZHANG, SHANGHAI (CN)

(72) Inventors: Zheng LIU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/851,043

(22) Filed: Jun. 28, 2022

Related U.S. Application Data
(63) Continuation of application No. PCT/CN2020/139912, filed on Dec. 28, 2020.

(30) Foreign Application Priority Data
Jan. 8, 2020 (CN) 202010017700.7

(51) Int. Cl. H04W 24/08; H04W 72/04

(52) U.S. Cl. CPC H04W 24/08; H04W 72/042; H04W 72/0446; H04W 72/0453

(57) ABSTRACT

The present application provides a method and a device in a node used for wireless communications. The node receives first information, the first information being used to determine a first time length; transmits a first signal, time-frequency resources occupied by the first signal being used to indicate a first identifier; and monitors a first signaling in a first time window, the first identifier being used for monitoring the first signaling; the first signal comprises X sub-signals, where X is a positive integer greater than 1, a first symbol set is used to generate any one of the X sub-signals, the X sub-signals are respectively X repetitions of the first symbol set; X is used to determine a second time length. The present disclosure can reduce the power consumption.

### CROSS REFERENCE TO RELATED APPLICATIONS

This application is the continuation of International patent application PCT/CN2020/139912, filed on Dec. 28, 2020, which claims the priority benefit of Chinese Patent Application No. 202010017700.7, filed on Jan. 8, 2020, the full disclosure of which is incorporated herein by reference.

### BACKGROUND

### Technical Field

The present application relates to transmission methods and devices in wireless communication systems, and in particular to a transmission scheme and a device for random access in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

For better adaptability to diverse application scenarios and fulfillment of various requests, the 3GPP RAN #75 Plenary approved a study item of Non-Terrestrial Networks (NTN) under NR, which was started with R15 of Technical Specifications. It was decided at the 3GPP RAN #79 Plenary that solutions in NTN will be studied and at the 3GPP RAN #86 Plenary that a WI is to be initiated to standardize relevant techniques and studies are to be conducted on NTN and Internet of Things (IoT), including combined application of Narrowband Internet of Things (NB-IoT) and Enhanced Machine Type Communications (eMTC).

### SUMMARY

In NTN and similar networks with a great transmission delay and a large transmission delay difference, requirements for a large transmission delay difference and uplink and downlink transmissions with sync may lead to a result that the current (e.g., NR 5G Release 16) design based on traditional Terrestrial Networks cannot be directly reused, particularly, the traditional random access design may not be applicable in NTN, therefore, new designs are required to support networks with large transmission delay and large transmission delay difference to guarantee normal communications. Besides, specific design requirements are particularly posed on random access in NB-IoT and eMTC networks, or similar networks with low UE complexity and large-capacity requirement.

In view of the issue that the design in the existing Internet of Things cannot work or work effectively because of a large delay in the large-delay network, the present application provides a solution. It should be noted that the description above only took NTN and IoT scenarios as a typical example or application scenario, but the present application also applies to other scenarios confronting similar problems, such as other large-delay networks or those having special requirements for random access, where similar technical effects can be achieved. Additionally, the adoption of a unified solution for various scenarios, including but not limited to NTN and IoT scenarios, contributes to the reduction of hardcore complexity and costs. If no conflict is incurred, embodiments in the first node in the present application and the characteristics of the embodiments are also applicable to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:

receiving first information, the first information being used to determine a first time length, the first time length being larger than 0;

transmitting a first signal, time-frequency resources occupied by the first signal being used to indicate a first identifier; and

monitoring a first signaling in a first time window, the first identifier being used for monitoring the first signaling;

herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, to determine a start of the first time window by an end time of transmitting the first signal, the first time length and the second time length, collectively, ensures that the overhead of power used for monitoring random access response can be reduced according to NTN transmission delay conditioned on fulfillment of requirements for low-cost UE re-sync by the delay of random access response in NB-IoT or eMTC within NTN coverage.

In one embodiment, by taking full account of the first and the second time lengths when calculating a start of the first time window, not only a reservation of excessive delay in the time window of random access response (RAR) can be avoided, but UEs in NB-IoT or eMTC are supported to select respective numbers of PRACH repetitions based on coverage situations, thus determining the RAR time window delay and ensuring the random access capacity.

According to one aspect of the present application, the above method is characterized in further comprising:

receiving second information and determining a first measurement value;

here, the second information is used to determine a first integer set, the first integer set comprising a positive integer number of positive integer(s); X is equal to a positive integer comprised in the first integer set, the first measurement value being used to determine X from the first integer set.

According to one aspect of the present application, the above method is characterized in further comprising:

receiving second information and determining a first measurement value;

herein, the second information is used to determine a first integer set, the first integer set comprising a positive integer number of positive integer(s); X is equal to a positive integer comprised in the first integer set, the first measurement value being used to determine X from the first integer set; the second information is used to determine a first time-frequency resource set, the first time-frequency resource set comprising a positive integer number of time-frequency resource subset(s), time-frequency resources occupied by the first signal belong to a target time-frequency resource subset, the target time-frequency resource subset being a time-frequency resource subset comprised in the first time-frequency resource set; the first measurement value is used to determine the target time-frequency resource subset from the first time-frequency resource set, the first node randomly selects time-frequency resources occupied by the first signal in the target time-frequency resource subset.

According to one aspect of the present application, the above method is characterized in further comprising:

receiving third information;

herein, the third information is used to determine a third time length, the third time length being equal to a positive integral multiple of a duration of a characteristic period; the third time length is used to determine a time length of the first time window.

According to cone aspect of the present application, the above method is characterized in that a larger value of the first time length and the second time length is used to determine a target time length, the target time length being used to determine a length of a time interval between a start of the first time window and an end time of transmitting the first signal.

In one embodiment, the determination of a start of the first time window by selecting a larger value of the first time length and the second time length enables comprehensive consideration of NTN transmission delay and requirements of NB-IoT/eMTC for delay and ensures a maximized reduction of UE power consumption based on NTN transmission delay on the condition that requirements of NB-IoT/eMTC are fulfilled.

According to cone aspect of the present application, the above method is characterized in that the first time length is equal to one of P candidate time lengths, where P is a positive integer greater than 1, the first information is used to determine the first time length out of the P candidate time lengths; the P candidate time lengths are pre-defined, and there is a candidate time length equal to 0 among the P candidate time lengths.

According to cone aspect of the present application, the above method is characterized in that X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

According to one aspect of the present application, the above method is characterized in further comprising:

transmitting a second signal;

receiving a third signal;

herein, when an end time of transmitting the second signal is earlier than a start time of receiving the third signal, the first time length is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.

In one embodiment, the first time length is also used to determine a delay between the second signal and the third signal, which in turn can be used to calculate a UL-DL scheduling delay, a HARQ-ACK feedback delay, an SRS triggering delay, a CSI report triggering delay or a starting delay of an RAR window reused for a delay between CSI feedback and reference CSI-RS, thus avoiding introducing extra signaling overhead.

The present application provides a method in a second node for wireless communications, comprising:

transmitting first information, the first information being used to indicate a first time length, the first time length being larger than 0;

receiving a first signal, time-frequency resources occupied by the first signal being used to indicate a first identifier; and

transmitting a first signaling in a first time window, the first signaling carrying the first identifier;

herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

According to one aspect of the present application, the above method is characterized in further comprising:

transmitting second information;

here, the second information is used to indicate a first integer set, the first integer set comprising a positive integer number of positive integer(s); X is equal to a positive integer comprised in the first integer set, a measurement performed by the first node in the present application being used to determine X from the first integer set.

According to one aspect of the present application, the above method is characterized in further comprising:

transmitting second information;

herein, the second information is used to indicate a first integer set, the first integer set comprising a positive integer number of positive integer(s); X is equal to a positive integer comprised in the first integer set, a measurement performed by the first node in the present application being used to determine X from the first integer set; the second information is used to indicate a first time-frequency resource set, the first time-frequency resource set comprising a positive integer number of time-frequency resource subset(s), time-frequency resources occupied by the first signal belong to a target time-frequency resource subset, the target time-frequency resource subset being a time-frequency resource subset comprised in the first time-frequency resource set; the measurement performed by the first node in the present application is used to determine the target time-frequency resource subset from the first time-frequency resource set, the first node in the present application randomly selects time-frequency resources occupied by the first signal in the target time-frequency resource subset.

According to one aspect of the present application, the above method is characterized in further comprising:

transmitting third information;

herein, the third information is used to indicate a third time length, the third time length being equal to a positive integral multiple of a duration of a characteristic period; the third time length is used to determine a time length of the first time window.

According to cone aspect of the present application, the above method is characterized in that a larger value of the first time length and the second time length is used to determine a target time length, the target time length being used to determine a length of a time interval between a start of the first time window and an end time of transmitting the first signal.

According to cone aspect of the present application, the above method is characterized in that the first time length is equal to one of P candidate time lengths, where P is a positive integer greater than 1, the first information is used to indicate the first time length out of the P candidate time lengths; the P candidate time lengths are pre-defined, and there is a candidate time length equal to 0 among the P candidate time lengths.

According to cone aspect of the present application, the above method is characterized in that X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

According to one aspect of the present application, the above method is characterized in further comprising:

receiving a second signal; and

transmitting a third signal;

herein, when an end time of transmitting the second signal is earlier than a start time of receiving the third signal, the first time length is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.

The present application provides a first node for wireless communications, comprising:

a first receiver, which receives first information, the first information being used to determine a first time length, the first time length being larger than 0;

a first transmitter, which transmits a first signal, time-frequency resources occupied by the first signal being used to indicate a first identifier; and

a second receiver, which monitors a first signaling in a first time window, the first identifier being used for monitoring the first signaling;

herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

The present application provides a second node for wireless communications, comprising:

a second transmitter, which transmits first information, the first information being used to indicate a first time length, the first time length being larger than 0;

a third receiver, which receives a first signal, time-frequency resources occupied by the first signal being used to indicate a first identifier; and

a third transmitter, which transmits a first signaling in a first time window, the first signaling carrying the first identifier;

herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the method in the present application has the following advantages:
using the method provided in the present application ensures that the overhead of power used for monitoring random access response can be reduced according to NTN transmission delay conditioned on fulfillment of requirements for low-cost UE re-synchronization by the delay of random access response in NB-IoT or eMTC within NTN coverage.
with the method provided in the present application, not only a reservation of excessive delay in the time window of random access response (RAR) can be avoided, but UEs in NB-IoT or eMTC are supported to select respective numbers of PRACH repetitions based on coverage situations, thus determining the RAR time window delay and ensuring the random access capacity.
the method in the present application enables comprehensive consideration of NTN transmission delay and requirements of NB-IoT/eMTC for delay and ensures a maximized reduction of UE power consumption based on NTN transmission delay on the condition that requirements of NB-IoT/eMTC are fulfilled.
the method in the present application can be used to calculate a UL-DL scheduling delay, a HARQ-ACK feedback delay, an SRS triggering delay, a CSI report triggering delay or a starting delay of an RAR window reused for a delay between CSI feedback and reference CSI-RS, thus avoiding introducing extra signaling overhead.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of first information, a first signal and a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first node and a second node according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a schematic diagram of a first integer set according to one embodiment of the present application.

FIG. 8 illustrates a schematic diagram of a relation between a first measurement value and a target time-frequency resource subset according to one embodiment of the present application.

FIG. 9 illustrates a schematic diagram of a third time length according to one embodiment of the present application.

FIG. 10 illustrates a schematic diagram of a target time length according to one embodiment of the present application.

FIG. 11 illustrates a schematic diagram of P candidate time lengths according to one embodiment of the present application.

FIG. 12 illustrates a schematic diagram of a relation between a first value range and a second time length according to one embodiment of the present application.

FIG. 13 illustrates a schematic diagram of a relation between a second signal and a third signal according to one embodiment of the present application.

FIG. 14 illustrates a structure block diagram of a processing device in a first node according to one embodiment of the present application.

FIG. 15 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

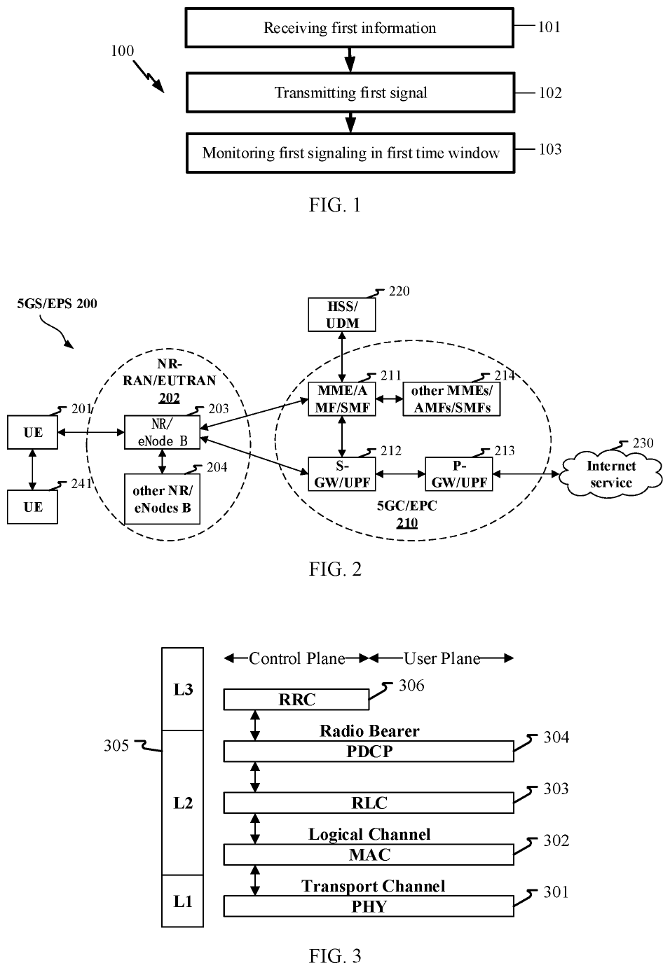

Embodiment 1 illustrates a flowchart of first information, a first signal and a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives first information in step 101, the first information being used to determine a first time length, the first time length being larger than 0; transmits a first signal in step 102, time-frequency resources occupied by the first signal being used to indicate a first identifier; and monitors a first signaling in a first time window in step 103, the first identifier being used for monitoring the first signaling; the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the first node is in a Radio Resource Control_IDLE (RRC_IDLE) State when transmitting the first signal.

In one embodiment, the first node is in a Radio Resource Control_CONNECTED (RRC_CONNECTED) State when transmitting the first signal.

In one embodiment, the first node is in a Radio Resource Control_INACTIVE (RRC_INACTIVE) State when transmitting the first signal.

In one embodiment, the first information is transmitted via an air interface.

In one embodiment, the first information is transmitted via a radio interface.

In one embodiment, the first information is transmitted via a higher layer signaling.

In one embodiment, the first information is transmitted via a physical layer signaling.

In one embodiment, the first information comprises all or part of a Higher Layer signaling.

In one embodiment, the first information comprises all or part of a physical layer signaling.

In one embodiment, the first information comprises all or part of Information Elements (IEs) in a Radio Resource Control (RRC) signaling.

In one embodiment, the first information comprises all or part of fields in an Information Element (IE) in an RRC signaling.

In one embodiment, the first information comprises all or part of a Medium Access Control (MAC) layer signaling.

In one embodiment, the first information comprises all or part of a Master Information Block (MIB).

In one embodiment, the first information comprises all or part of a System Information Block (SIB).

In one embodiment, the first information comprises all or part of a System Information Block Type 1 (SIB1).

In one embodiment, the first information is transmitted through a Downlink Shared Channel (DL-SCH).

In one embodiment, the first information is transmitted through a Physical Downlink Shared Channel (PDSCH).

In one embodiment, the first information is transmitted through a Narrowband Physical Downlink Shared Channel (NPDSCH).

In one embodiment, the first information is transmitted through a Machine-type Physical Downlink Shared Channel (MPDSCH).

In one embodiment, the first information is carried by a Physical Broadcast Channel (PBCH).

In one embodiment, the first information is carried by a Narrow-band Physical Broadcast Channel (NPBCH).

In one embodiment, the first information is Cell-Specific.

In one embodiment, the first information is UE-Specific.

In one embodiment, the first information is UE group-specific.

In one embodiment, the first information is Footprint-Specific.

In one embodiment, the first information is Beam Specific.

In one embodiment, the first information is Geographical-zone-Specific.

In one embodiment, the first information comprises all or partial fields in a Downlink Control Information (DCI) signaling.

In one embodiment, the first information belongs to an Information Element (IE) “RadioResourceConfigCommonSIB-NB”.

In one embodiment, the first information belongs to an Information Element (IE) “RACH-ConfigCommon-NB”.

In one embodiment, the first information belongs to an Information Element (IE) “RACH-InfoList-NB”.

In one embodiment, the first information belongs to an Information Element (IE) “RACH-Info-NB”.

In one embodiment, the first information belongs to a field “ra-ResponseWindowOffset” in an Information Element (IE) “RACH-ConfigCommon-NB”.

In one embodiment, the first information belongs to a field “ra-ResponseWindowOffset” in an Information Element (IE) “RACH-Info-NB”.

In one embodiment, the phrase that “the first information is used to determine a first time length” comprises the meaning that the first information is used by the first node in the present application to determine the first time length.

In one embodiment, the phrase that “the first information is used to determine a first time length” comprises the meaning that the first information is used to directly indicate the first time length.

In one embodiment, the phrase that “the first information is used to determine a first time length” comprises the meaning that the first information is used to indirectly indicate the first time length.

In one embodiment, the phrase that “the first information is used to determine a first time length” comprises the meaning that the first information is used to explicitly indicate the first time length.

In one embodiment, the phrase that “the first information is used to determine a first time length” comprises the meaning that the first information is used to implicitly indicate the first time length.

In one embodiment, the phrase that “the first information is used to determine a first time length” means that “the first information is used to determine the first time length out of the P candidate time lengths” in Claim 6 in the present application.

In one embodiment, the first time length is measured in milliseconds (ms).

In one embodiment, the first time length is measured in seconds (s).

In one embodiment, the first time length is expressed in a number of PDCCH Periods (PPs).

In one embodiment, the first time length is expressed in a number of Orthogonal Frequency Division Multiplexing (OFDM) Symbols.

In one embodiment, the first time length is expressed in a number of slots.

In one embodiment, the first time length is expressed in a number of subframes.

In one embodiment, the first time length is related to an altitude of the second node in the present application.

In one embodiment, the first time length is related to a distance from the second node in the present application to the Nadir.

In one embodiment, the first time length is related to a distance between the first node and the second node in the present application.

In one embodiment, the first time length is related to a type of the second node in the present application.

In one embodiment, the first time length is related to a traveling orbit of the second node in the present application.

In one embodiment, the first time length is related to an Ephemeris of the second node in the present application.

In one embodiment, the first time length is used to indicate a delay of an RAR window of the first node.

In one embodiment, the first time length is used to indicate a time length for which RAR monitoring is postponed by the first node.

In one embodiment, the first signal is transmitted through a Physical Random Access Channel (PRACH).

In one embodiment, the first signal is transmitted through a Narrowband Physical Random Access Channel (NPRACH).

In one embodiment, the first signal is a radio signal.

In one embodiment, the first signal is an air-interface signal.

In one embodiment, the first signal is a Baseband Signal.

In one embodiment, the first signal is a Radio Frequency (RF) signal.

In one embodiment, the phrase that “the first signal is used for a random access” comprises the meaning that the first signal is used for 4-step random access.

In one embodiment, the phrase that “the first signal is used for a random access” comprises the meaning that the first signal is used for 2-step random access.

In one embodiment, the phrase that “the first signal is used for a random access” comprises the meaning that the first signal is used for Type-1 random access.

In one embodiment, the phrase that “the first signal is used for a random access” comprises the meaning that the first signal is used for Type-2 random access.

In one embodiment, the first signal is used for an Msg1 in a 4-step random access.

In one embodiment, the first signal is used for an MsgA in a 2-step random access.

In one embodiment, a Zadoff-Chu (ZC) Sequence with a length of 839 is used for generating the first signal.

In one embodiment, a Zadoff-Chu (ZC) Sequence with a length of 139 is used for generating the first signal.

In one embodiment, a Zadoff-Chu (ZC) Sequence with a length larger than 839 is used for generating the first signal.

In one embodiment, the first signal carries a Preamble Sequence.

In one embodiment, time-frequency resources occupied by the first signal are time-frequency resources corresponding to a Random Access Occasion (RO).

In one embodiment, time-frequency resources occupied by the first signal comprise time-domain resources occupied by a Cyclic Prefix (CP).

In one embodiment, time-frequency resources occupied by the first signal comprise time-domain resources occupied by a Guard Period (GP).

In one embodiment, time-frequency resources occupied by the first signal are autonomously selected by the first node from multiple candidate time-frequency resources.

In one embodiment, the first identifier is a non-negative integer.

In one embodiment, the first identifier is a 16-digit binary integer.

In one embodiment, the first identifier is a Radio Network Temporary Identifier (RNTI).

In one embodiment, the first identifier is a Message B Radio Network Temporary Identity (MsgB-RNTI).

In one embodiment, the first identifier is a Random Access Radio Network Temporary Identity (RA-RNTI).

In one embodiment, the phrase of “time-frequency resources occupied by the first signal being used to indicate a first identifier” comprises the meaning that time-frequency resources occupied by the first signal are used by the first node in the present application to indicate the first identifier.

In one embodiment, the phrase of “time-frequency resources occupied by the first signal being used to indicate a first identifier” comprises the meaning that time-frequency resources occupied by the first signal are used for directly indicating the first identifier.

In one embodiment, the phrase of “time-frequency resources occupied by the first signal being used to indicate a first identifier” comprises the meaning that time-frequency resources occupied by the first signal are used for indirectly indicating the first identifier.

In one embodiment, the phrase of “time-frequency resources occupied by the first signal being used to indicate a first identifier” comprises the meaning that time-frequency resources occupied by the first signal are used for explicitly indicating the first identifier.

In one embodiment, the phrase of “time-frequency resources occupied by the first signal being used to indicate a first identifier” comprises the meaning that time-frequency resources occupied by the first signal are used for implicitly indicating the first identifier.

In one embodiment, the phrase of “time-frequency resources occupied by the first signal being used to indicate a first identifier” comprises the meaning that a position of time-frequency resources occupied by the first signal in time-frequency domain are used to indicate the first identifier.

In one embodiment, the phrase of “time-frequency resources occupied by the first signal being used to indicate a first identifier” comprises the meaning that a number of time-frequency resources occupied by the first signal is used to indicate the first identifier.

In one embodiment, the phrase of “time-frequency resources occupied by the first signal being used to indicate a first identifier” is implemented through the formula as follows:

RA-RNTI=1+s_id+14×t_id+14×80×f_id+14×80×8×ul_carrier_id

Herein, RA-RNTI represents the first identifier, s_id represents an index for an earliest OFDM symbol in time domain comprised in time-frequency resources occupied by the first signal (0≤s_id<14), t_id represents an index for a slot to which an earliest OFDM symbol in time domain comprised in time-frequency resources occupied by the first signal belongs in a system frame (0≤t_id<80), f_id represents an index for a frequency-domain resource in time-frequency resources occupied by the first signal (0≤f_id<8), ul_carrier_id represents an identifier for a carrier to which time-frequency resources occupied by the first signal belong in frequency domain.

In one embodiment, the phrase of “time-frequency resources occupied by the first signal being used to indicate a first identifier” is implemented through the formula as follows:

RA-RNTI=1+t_id+10×f_id

Herein, RA-RNTI represents the first identifier, t_id represents an index for a subframe to which an earliest OFDM symbol in time domain comprised in time-frequency resources occupied by the first signal belongs in a system frame (0≤t_id<10), f_id represents an index for a frequency-domain resource in time-frequency resources occupied by the first signal (0≤f_id<6).

In one embodiment, the phrase of “time-frequency resources occupied by the first signal being used to indicate a first identifier” is implemented through the formula as follows:

RA-RNTI=1+t_id+10×f_id+60×(SFN_id mod(Wmax/10))

Herein, RA-RNTI represents the first identifier, t_id represents an index for a subframe to which an earliest OFDM symbol in time domain comprised in time-frequency resources occupied by the first signal belongs in a system frame (0≤t_id<10), f_id represents an index for a frequency-domain resource in time-frequency resources occupied by the first signal (0≤f_id<6), SFN_id represents an index for a radio frame to which an earliest multicarrier symbol in time domain comprised in time-frequency resources occupied by the first signal belongs, Wmax represents a maximum possible Random Access Response (RAR) Window size.

In one embodiment, the phrase of “time-frequency resources occupied by the first signal being used to indicate a first identifier” is implemented through the formula as follows:

RA-RNTI=1+floor(SFN_id/4)+256×carrier_id

Herein, RA-RNTI represents the first identifier, SFN_id represents an index for a radio frame to which an earliest multicarrier symbol in time domain comprised in time-frequency resources occupied by the first signal belongs, carrier_id represents an index for a carrier to which time-frequency resources occupied by the first signal belong in frequency domain.

In one embodiment, the phrase of “time-frequency resources occupied by the first signal being used to indicate a first identifier” is implemented through the formula as follows:

RA-RNTI=1+floor(SFN_id/4)+256×(H-SFN mod 2)

Herein, RA-RNTI represents the first identifier, SFN_id represents an index for a radio frame to which an earliest multicarrier symbol in time domain comprised in time-frequency resources occupied by the first signal belongs, H-SFN represents an index for a hyper frame to which an earliest multicarrier symbol in time domain comprised in time-frequency resources occupied by the first signal belongs.

In one embodiment, the phrase of “time-frequency resources occupied by the first signal being used to indicate a first identifier” comprises the meaning that time-frequency resources occupied by the first signal are used to indicate an RA-RNTI, the RA-RNTI being used to indicate the first identifier.

In one embodiment, the first time window is a Random Access Response Window.

In one embodiment, the first time window is an MsgB Response Window.

In one embodiment, the first time window comprises a positive integer number of Physical Downlink Control Channel Period(s) (PP(s)).

In one embodiment, the first time window is of a time length larger than 0.

In one embodiment, the first time window comprises a positive integer number of consecutive slots with a given subcarrier spacing.

In one embodiment, the first time window comprises a positive integer number of consecutive OFDM Symbols with a given subcarrier spacing.

In one embodiment, the first time window comprises a positive integer number of consecutive subframe s.

In one embodiment, the first time window is used for monitoring an Msg2 in a 4-step random access procedure.

In one embodiment, the first time window is used for monitoring an MsgB in a 2-step random access procedure.

In one embodiment, the fourth receiver receives a fourth signal; herein, the fourth signal carries a Random Access Response (RAR), the first signaling being used to determine time-frequency resources occupied by the fourth signal and a Modulation Coding Scheme (MCS) used by the fourth signal.

In one embodiment, monitoring of the first signaling is implemented by means of decoding of the first signaling.

In one embodiment, monitoring of the first signaling is implemented by means of blind decoding of the first signaling.

In one embodiment, monitoring of the first signaling is implemented by means of decoding and CRC of the first signaling.

In one embodiment, monitoring of the first signaling is implemented by means of decoding and

CRC of the first signaling, the CRC being scrambled by the first identifier.

In one embodiment, monitoring of the first signaling is implemented by means of decoding of the first signaling based on a format of the first signaling.

In one embodiment, the first signaling is transmitted via an air interface.

In one embodiment, the first signaling is transmitted via a radio interface.

In one embodiment, the first signaling is transmitted via a Uu interface.

In one embodiment, the first signaling is a physical layer signaling.

In one embodiment, the first signaling is transmitted through a Physical Downlink Control Channel (PDCCH).

In one embodiment, the first signaling is transmitted through a Narrowband Physical Downlink Control Channel (NPDCCH).

In one embodiment, the first signaling comprises all or partial fields in Downlink Control Information (DCI).

In one embodiment, the first signaling comprises all or partial fields in Downlink Control Information (DCI) with a given DCI format.

In one embodiment, the first signaling comprises all or partial fields in Downlink Control Information (DCI) with a DCI Format N1.

In one embodiment, the first signaling is DCI scheduling a Physical Downlink Shared Channel (PDSCH) carrying a random access response.

In one embodiment, the first signaling is DCI scheduling a Narrowband Physical Downlink Shared Channel (NPDSCH) carrying a random access response.

In one embodiment, the first signaling is DCI scheduling a Physical Downlink Shared Channel (PDSCH) carrying an MsgB.

In one embodiment, the first signaling is DCI scheduling a Narrowband Physical Downlink Shared Channel (NPDSCH) carrying an MsgB.

In one embodiment, the first signaling is an NPDCCH scheduling a Narrowband Physical Downlink Shared Channel (NPDSCH) carrying an MsgB.

In one embodiment, the phrase of “the first identifier being used for monitoring the first signaling” comprises a meaning that the first identifier is used by the first node in the present application for monitoring the first signaling.

In one embodiment, the phrase of “the first identifier being used for monitoring the first signaling” comprises a meaning that the monitoring of the first signaling is implemented by means of decoding of the first signaling and CRC scrambled by the first identifier.

In one embodiment, the phrase of “the first identifier being used for monitoring the first signaling” comprises a meaning that the first identifier is used for scrambling the first signaling.

In one embodiment, the phrase of “the first identifier being used for monitoring the first signaling” comprises a meaning that the first identifier is used for scrambling of CRC of the first signaling.

In one embodiment, the phrase of “the first identifier being used for monitoring the first signaling” comprises a meaning that the first identifier is used to determine whether the first signaling is detected in the procedure of monitoring the first signaling.

In one embodiment, X is equal to a positive integral multiple of 4.

In one embodiment, X is equal to 4 times the size of Y, where Y is equal to a positive integral power of 2.

In one embodiment, X is equal to a positive integral power of 2.

In one embodiment, time-frequency resources occupied by any two sub-signals among the X sub-signals are orthogonal.

In one embodiment, any sub-signal among the X sub-signals occupies a subcarrier in frequency domain.

In one embodiment, there is one sub-signal among the X sub-signals that occupies more than one subcarrier in frequency domain.

In one embodiment, any two sub-signals among the X sub-signals occupy equal numbers of frequency-domain resources in frequency domain.

In one embodiment, any two sub-signals among the X sub-signals occupy same frequency-domain resources in frequency domain.

In one embodiment, there are two sub-signals among the X sub-signals that occupy different frequency-domain resources in frequency domain.

In one embodiment, there are two sub-signals among the X sub-signals that occupy unequal numbers of frequency-domain resources in frequency domain.

In one embodiment, any two sub-signals among the X sub-signals occupy equal numbers of time-domain resources in time domain.

In one embodiment, there are two sub-signals among the X sub-signals that occupy unequal numbers of time-domain resources in time domain.

In one embodiment, any sub-signal among the X sub-signals comprises a cyclic prefix and a positive integer number of same symbols.

In one embodiment, any sub-signal among the X sub-signals is a transmission of a preamble.

In one embodiment, any sub-signal among the X sub-signals is a transmission of a Symbol Group in a preamble.

In one embodiment, any sub-signal among the X sub-signals is a preamble repetition unit.

In one embodiment, any sub-signal among the X sub-signals is a part of a preamble repetition unit.

In one embodiment, any sub-signal among the X sub-signals is a frequency-hopping unit in a preamble repetition unit.

In one embodiment, any sub-signal among the X sub-signals is a transmission of a single-subcarrier frequency-hopping symbol group in a preamble repetition unit.

In one embodiment, the first signal only comprises the X sub-signals.

In one embodiment, the first signal also comprises one or more sub-signals other than the X sub-signals.

In one embodiment, the first symbol set is a Symbol Group comprised in a Preamble.

In one embodiment, the first symbol set comprises symbols in all Symbol Groups comprised in a Preamble.

In one embodiment, the first symbol set is a single-subcarrier frequency-hopping symbol group.

In one embodiment, the first symbol set comprises more than one single-subcarrier frequency-hopping symbol group.

In one embodiment, the first symbol set comprises 4 single-subcarrier frequency-hopping symbol groups.

In one embodiment, the first symbol set comprises 6 single-subcarrier frequency-hopping symbol groups.

In one embodiment, the first symbol set is a Random Access symbol group.

In one embodiment, the first symbol set comprises more than one Random Access symbol group.

In one embodiment, the first symbol set consists of all Symbol Groups comprised in a preamble repetition unit.

In one embodiment, the first symbol set comprises all symbols comprised in a preamble repetition unit.

In one embodiment, all symbols comprised in the first symbol set are the same.

In one embodiment, all symbols excluding cyclic prefixes (CP) comprised in the first symbol set are the same.

In one embodiment, any symbol comprised in the first symbol set is a sine-wave symbol.

In one embodiment, any symbol in the first symbol set is a sine-wave symbol not subject to modulation.

In one embodiment, the first symbol set comprises a cyclic prefix and a positive integer number of same symbols.

In one embodiment, the first symbol set comprises a cyclic prefix and a symbol.

In one embodiment, the first symbol set is generated by a sequence with all elements being “1”.

In one embodiment, the phrase that “the first symbol set is used to generate any sub-signal among the X sub-signals” comprises a meaning that the first symbol set is used by the first node in the present application to generate any sub-signal among the X sub-signals.

In one embodiment, the phrase that “the first symbol set is used to generate any sub-signal among the X sub-signals” comprises a meaning that any sub-signal among the X sub-signals is generated by the first symbol set sequentially through Time and Frequency Mapping, Baseband Signal Generation and Modulation and Upconversion.

In one embodiment, the phrase that “the first symbol set is used to generate any sub-signal among the X sub-signals” comprises a meaning that any sub-signal among the X sub-signals is generated by the first symbol set sequentially through Time and Frequency Mapping, and Baseband Signal Generation.

In one embodiment, the phrase that “the X sub-signals are respectively X repetitions of the first symbol set” comprises the meaning that the X sub-signals are respectively X time-domain repetitions of the first symbol set.

In one embodiment, the phrase that “the X sub-signals are respectively X repetitions of the first symbol set” comprises the meaning that the first symbol set being transmitted for X times is used for respectively generating the X sub-signals.

In one embodiment, the phrase that “the X sub-signals are respectively X repetitions of the first symbol set” comprises the meaning that any sub-signal among the X sub-signals carries the first symbol set as a whole.

In one embodiment, the phrase that “the X sub-signals are respectively X repetitions of the first symbol set” comprises the meaning that any sub-signal among the X sub-signals is independently generated by the first symbol set.

In one embodiment, the phrase that “the X sub-signals are respectively X repetitions of the first symbol set” comprises the meaning that a first sub-signal is one of the X sub-signals, the first symbol set is used to generate the first sub-signal, and a time-domain wave for the first sub-signal being transmitted for X times generates the X sub-signals.

In one embodiment, the phrase that “X is used to determine a second time length” comprises the meaning that the X is used by the first node in the present application to determine the second time length.

In one embodiment, the phrase that “X is used to determine a second time length” comprises the meaning that the X is used to determine the second time length based on a mapping relationship.

In one embodiment, the phrase that “X is used to determine a second time length” comprises the meaning that the X is used to determine the second time length based on a table-based correspondence relationship.

In one embodiment, the phrase that “X is used to determine a second time length” comprises the meaning that the X is used to determine the second time length based on a functional relationship.

In one embodiment, the phrase that “X is used to determine a second time length” comprises the meaning that a range where the X is included is used to determine the second time length.

In one embodiment, the phrase that “X is used to determine a second time length” comprises the meaning that a value range where the X belongs is used to determine the second time length.

In one embodiment, the phrase that “X is used to determine a second time length” is implemented via the Claim 7 in the present application.

In one embodiment, the phrase that “X is used to determine a second time length” is implemented via a method other than the Claim 7 in the present application.

In one embodiment, the second time length is measured in milliseconds (ms).

In one embodiment, the second time length is measured in seconds (s).

In one embodiment, the second time length is expressed in a number of PDCCH Periods (PPs).

In one embodiment, the second time length is expressed in a number of Orthogonal Frequency Division Multiplexing (OFDM) Symbols.

In one embodiment, the second time length is expressed in a number of subframes.

In one embodiment, the second time length is measured in a same unit as the first time length.

In one embodiment, the second time length and the first time length are comparable.

In one embodiment, the second time length is a time length required for Re-synchronization for the first node upon transmission of a PRACH.

In one embodiment, the second time length is a time length required to be idle after the first node transmits a PRACH and before its monitoring of an RAR.

In one embodiment, the phrase that “an end time of transmitting the first signal, the first time length and the second time length are used together to determine a start of the first time window” comprises the meaning that an end time of transmitting the first signal, the first time length and the second time length are jointly used by the first node in the present application to determine a start of the first time window.

In one embodiment, the phrase that “an end time of transmitting the first signal, the first time length and the second time length are used together to determine a start of the first time window” refers to the claim 5 in the present application.

In one embodiment, the phrase that “an end time of transmitting the first signal, the first time length and the second time length are used together to determine a start of the first time window” comprises the meaning that the first time length and the second time length are jointly used to determine a time interval length between a start of the first time window and an end time of transmitting the first signal.

In one embodiment, the phrase that “an end time of transmitting the first signal, the first time length and the second time length are used together to determine a start of the first time window” comprises the meaning that the first time length and the second time length are jointly used to calculate a time interval length between a start of the first time window and an end time of transmitting the first signal.

In one embodiment, the phrase that “an end time of transmitting the first signal, the first time length and the second time length are used together to determine a start of the first time window” comprises the meaning that a sum of the first time length and the second time length is used to calculate a time interval length between a start of the first time window and an end time of transmitting the first signal.

In one embodiment, the phrase that “an end time of transmitting the first signal, the first time length and the second time length are used together to determine a start of the first time window” comprises the meaning that a larger value of the first time length and the second time length is used to calculate a time interval length between a start of the first time window and an end time of transmitting the first signal.

In one embodiment, an end time of transmitting the first signal refers to an end time of time-domain resources occupied by the first signal.

In one embodiment, an end time of transmitting the first signal refers to an end time of a last OFDM symbol occupied by the first signal.

In one embodiment, an end time of transmitting the first signal refers to an end time of a subframe comprising an end of transmission of the first signal.

In one embodiment, an end time of transmitting the first signal refers to a start time of a subframe comprising an end of transmission of the first signal.

In one embodiment, an end time of transmitting the first signal refers to an end time of a Guard Period (GP) corresponding to the first signal.

### Embodiment 2

Embodiment 2 illustrates a schematic diagram of a network architecture according to the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN comprises an NR/evolved node B (gNB/eNB) 203 and other gNBs (eNBs) 204. The gNB(eNB) 203 provides UE 201 oriented user plane and control plane terminations. The gNB(eNB) 203 may be connected to other gNBs(eNBs) 204 via an Xn/X2 interface (for example, backhaul). The gNB(eNB) 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB(eNB) 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB(eNB) 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 supports transmissions in networks with large propagation delay.

In one embodiment, the UE 201 supports transmissions in networks with wide-range transmission delay differences.

In one embodiment, the UE 201 supports NTN.

In one embodiment, the UE 201 supports NB-IoT.

In one embodiment, the UE 201 supports eMTC networks.

In one embodiment, the gNB(eNB) 203 corresponds to the second node in the present application.

In one embodiment, the gNB(eNB) 203 supports transmissions in networks with large propagation delay.

In one embodiment, the gNB(eNB) 203 supports transmissions in networks with wide-range transmission delay difference.

In one embodiment, the gNB(eNB) 203 supports NTN.

In one embodiment, the gNB(eNB) 203 supports NB-IoT.

In one embodiment, the gNB(eNB) 203 supports eMTC networks.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane and a control plane. In FIG. 3, the radio protocol architecture for a control plane between a first node (UE) and a second node (gNB, eNB, or, satellite or aircraft in NTN), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node via the PHY 301. In the user plane, the L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes of the network side. Although not described in FIG. 3, the first node may comprise several higher layers above the L2 305, such as a network layer (i.e., IP layer) terminated at a P-GW 213 of the network side and an application layer terminated at the other side of the connection (i.e., a peer UE, a server, etc.). The PDCP sublayer 304 provides multiplexing among variable radio bearers and logical channels. The PDCP sublayer 304 also provides header compression used for an upper-layer packet for a reduction of radio transmission overhead, provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transmission channel. The MAC sublayer 302 is also responsible for allocating between first nodes various radio resources (i.e., resource block) in a cell. The MAC sublayer 302 is also in charge of HARQ operation. In the control plane, a radio protocol architecture used for the first node and the second node is almost the same as that for a PHY 301 and a L2 305, but without the functionality of header compression used for the control plane. The control plane also comprises a Radio Resource Control (RRC) sublayer 306 in the L3 layer. The RRC sublayer 306 is responsible for acquiring radio resources (i.e., radio bearer) and configuring the lower layer using an RRC signaling between the second node and the first node.

In one embodiment, the first information in the present application is generated by the RRC 306.

In one embodiment, the first information in the present application is generated by the MAC 302.

In one embodiment, the first information in the present application is generated by the PHY 301.

In one embodiment, the first signal in the present application is generated by the MAC 302.

In one embodiment, the first signal in the present application is generated by the PHY 301.

In one embodiment, the first signaling in the present application is generated by the MAC 302.

In one embodiment, the first signaling in the present application is generated by the PHY 301.

In one embodiment, the second information in the present application is generated by the RRC 306.

In one embodiment, the second information in the present application is generated by the MAC 302.

In one embodiment, the second information in the present application is generated by the PHY 301.

In one embodiment, the third information in the present application is generated by the RRC 306.

In one embodiment, the third information in the present application is generated by the MAC 302.

In one embodiment, the third information in the present application is generated by the PHY 301.

In one embodiment, the second signal in the present application is generated by the RRC 306.

In one embodiment, the second signal in the present application is generated by the MAC 302.

In one embodiment, the second signal in the present application is generated by the PHY 301.

In one embodiment, the third signal in the present application is generated by the RRC 306.

In one embodiment, the third signal in the present application is generated by the MAC 302.

In one embodiment, the third signal in the present application is generated by the PHY 301.

### Embodiment 4

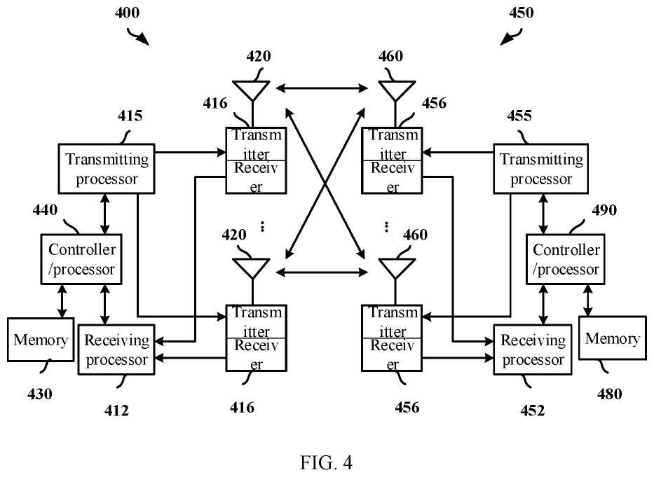

Embodiment 4 illustrates a schematic diagram of a first node and a second node according to the present application, as shown in FIG. 4.

The first node (450) can comprise a controller/processor 490, a data source/buffer 480, a receiving processor 452, a transmitter/receiver 456 and a transmitting processor 455, where the transmitter/receiver 456 comprises an antenna 460.

The second node (410) can comprise a controller/processor 440, a data source/buffer 430, a receiving processor 412, a transmitter/receiver 416 and a transmitting processor 415, where the transmitter/receiver 416 comprises an antenna 420.

In Downlink (DL), a higher-layer packet, for instance higher-layer information contained in first information, second information, and third information, higher-layer information contained in a first signaling (if any) and higher-layer information contained in the third signal (if any) in the present application are provided to the controller/processor 440. The controller/processor 440 provides functions of the L2 layer and above. In DL, the controller/processor 440 provides header compression, encryption, packet segmentation and reordering, multiplexing between a logical channel and a transport channel and radio resource allocation of the first node 450 based on various priorities. The controller/processor 440 is responsible for HARQ operation, retransmission of a lost packet and a signaling to the first node device 450, for example, the first information, the second information and the third information in the present application are generated in the controller/processor 440. The transmitting processor 415 performs various signal processing functions used for the L1 (that is, PHY), including coding, interleaving, scrambling, modulation, power control/allocation, precoding and physical layer control signaling generation, for example, the generation of physical layer signals of the first information, second information, and third information in the present application and the generation of physical layer signals of the first signaling and the third signal in the present application are completed in the transmitting processor 415. Modulation symbols generated are divided into parallel streams and each stream is mapped to a corresponding multicarrier subcarrier and/or multicarrier symbol, and then is mapped to the antenna 420 by the transmitting processor 415 via the transmitter 416 and transmitted in the form of radio frequency signals. At the receiving end, each receiver 456 receives a radio frequency signal via a corresponding antenna 460, resumes baseband information modulated onto the radio frequency carriers and provides the baseband information to the receiving processor 452. The receiving processor 452 performs various signal reception processing functions of the L1 layer. The signal reception processing functions include receiving physical layer signals of the first information, second information, and third information in the present application and receiving physical layer signals of the first signaling and a third signal, and demodulating multicarrier symbols in multicarrier symbol flows based on each modulation scheme (e.g., BPSK, QPSK), de-scrambling, decoding and de-interleaving to recover data or control signal transmitted by the second node 410 on a physical channel, and then providing the data and control signal to the controller/processor 490. The controller/processor 490 is in charge of the L2 and layers above, the controller/processor 490 interpreting higher-layer information contained in first information, second information, and third information, and higher-layer information contained in a first signaling (if any) and higher-layer information contained in the third signal (if any). The controller/processor can be associated with a memory 480 that stores program code and data. The memory 480 can be called a computer readable medium.

In UL, the data source/buffer 480 can be used to provide higher-layer data to the controller/processor 490. The data source/buffer 480 represents the L2 and all protocol layers above L2, higher-layer information or data carried in the second signal in the present application is provided to the controller/processor 490 by the data source/buffer 480. The controller/processor 490 provides header compression, encryption, packet segmentation and reordering as well as multiplexing between a logical channel and a transport channel based on radio resources allocation of the second node 410, thereby implementing the L2 layer protocols used for the user plane and the control plane. The controller/processor 490 is responsible for HARQ operation, retransmission of a lost packet and a signaling to the second node 410. The transmitting processor 455 perform various signal transmitting processing functions used for the L1 layer (i.e., PHY), e.g., physical layer signals of the first signal and physical layer signals of the second signal in the present application are generated in the transmitting processor 455. The signal transmitting processing functions include sequence generation (for signals generated by a sequence), coding and interleaving to ensure a Forward Error Correction (FEC) of the UE 450 as well as modulation of baseband signals (for signals generated by bit blocks) based on each modulation scheme (e.g., BPSK, QPSK), dividing sequence-generated signals and modulation symbols into parallel streams and mapping each stream onto a corresponding multicarrier subcarrier and/or multicarrier symbol, which are then mapped to the antenna 460 by the transmitting processor 455 via the transmitter 456 and transmitted in the form of radio frequency signals. The receiver 416 receives a radio frequency signal via a corresponding antenna 420, each resumes baseband information modulated onto the radio frequency carriers and provides the baseband information to the receiving processor 412. The receiving processor 412 performs various signal receiving processing functions used for the L1 layer (i.e., PHY), which include receiving physical layer signals of the first signal and second signal in the present application, and also acquiring multicarrier symbol flows and demodulating multicarrier symbols within relative to sequence decorrelation and based on each modulation scheme (e.g., BPSK, QPSK), de-scrambling and de-interleaving to recover data or control signal originally transmitted by the first node 450 on a physical channel Next, the data and/or control signal are provided to the controller/processor 440. The controller/processor 440 provides functions of the L2 layer, including reading higher-layer information carried by the second signal in the present application. The controller/processor can be associated with a buffer 430 that stores program code and data, the buffer 430 may be called a computer readable medium.

In one embodiment, the first node 450 comprises at least one processor and at least one memory. The at least one memory includes computer program codes. The at least one memory and the computer program codes are configured to be used in collaboration with the at least one processor. The UE 450 at least receives first information, the first information being used to determine a first time length, the first time length being larger than 0; transmits a first signal, time-frequency resources occupied by the first signal being used to indicate a first identifier; and monitors a first signaling in a first time window, the first identifier being used for monitoring the first signaling; herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the first node 450 comprises a memory that stores a computer readable instruction program. The computer readable instruction program generates an action when executed by at least one processor. The action includes: receiving first information, the first information being used to determine a first time length, the first time length being larger than 0; transmitting a first signal, time-frequency resources occupied by the first signal being used to indicate a first identifier; and monitoring a first signaling in a first time window, the first identifier being used for monitoring the first signaling; herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the second node 410 comprises at least one processor and at least one memory. The at least one memory comprises computer program codes; the at least one memory and the computer program codes are configured to be used in collaboration with the at least one processor. The second node 410 at least transmits first information, the first information being used to indicate a first time length, the first time length being larger than 0; receives a first signal, time-frequency resources occupied by the first signal being used to determine a first identifier; and transmits a first signaling in a first time window, the first signaling carrying the first identifier; herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the second node 410 comprises a memory that stores a computer readable instruction program. The computer readable instruction program generates an action when executed by at least one processor. The action includes: transmitting first information, the first information being used to indicate a first time length, the first time length being larger than 0; receiving a first signal, time-frequency resources occupied by the first signal being used to determine a first identifier; and transmitting a first signaling in a first time window, the first signaling carrying the first identifier; herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the first node 450 is a UE.

In one embodiment, the first node 450 is a UE supporting large delay transmissions.

In one embodiment, the first node 450 is a UE supporting NTN.

In one embodiment, the first node 450 is a UE supporting NB-IoT.

In one embodiment, the first node 450 is a UE supporting eMTC networks.

In one embodiment, the second node 410 is a base station (gNB/eNB).

In one embodiment, the second node 410 is a base station supporting large transmission delay.

In one embodiment, the second node 410 is a base station supporting NTN.

In one embodiment, the second node 410 is a base station supporting NB-IoT.

In one embodiment, the second node 410 is a base station supporting eMTC networks.

In one embodiment, the second node 410 is a satellite device.

In one embodiment, the second node 410 is a flight platform.

In one embodiment, the receiver 456 (comprising the antenna 460), the receiving processor 452 and the controller/processor 490 are used for receiving the first information in the present application.

In one embodiment, the transmitter 456 (comprising the antenna 460), the transmitting processor 455 and the controller/processor 490 are used for transmitting the first signal in the present application.

In one embodiment, the receiver 456 (comprising the antenna 460), the receiving processor 452 and the controller/processor 490 are used for receiving the first signaling in the present application.

In one embodiment, the receiver 456 (comprising the antenna 460), the receiving processor 452 and the controller/processor 490 are used for receiving the second information in the present application.

In one embodiment, the receiver 456 (comprising the antenna 460), the receiving processor 452 and the controller/processor 490 are used for receiving the third information in the present application.

In one embodiment, the transmitter 456 (comprising the antenna 460), the transmitting processor 455 and the controller/processor 490 are used for transmitting the second signal in the present application.

In one embodiment, the receiver 456 (comprising the antenna 460), the receiving processor 452 and the controller/processor 490 are used for receiving the third signal in the present application.

In one embodiment, the transmitter 416 (comprising the antenna 420), the transmitting processor 415 and the controller/processor 440 are used for transmitting the first information in the present application.

In one embodiment, the receiver 416 (comprising the antenna 420), the receiving processor 412 and the controller/processor 440 are used for receiving the first signal in the present application.

In one embodiment, the transmitter 416 (comprising the antenna 420), the transmitting processor 415 and the controller/processor 440 are used for transmitting the first signaling in the present application.

In one embodiment, the transmitter 416 (comprising the antenna 420), the transmitting processor 415 and the controller/processor 440 are used for transmitting the second information in the present application.

In one embodiment, the transmitter 416 (comprising the antenna 420), the transmitting processor 415 and the controller/processor 440 are used for transmitting the third information in the present application.

In one embodiment, the receiver 416 (comprising the antenna 420), the receiving processor 412 and the controller/processor 440 are used for receiving the second signal in the present application.

In one embodiment, the transmitter 416 (comprising the antenna 420), the transmitting processor 415 and the controller/processor 440 are used for transmitting the third signal in the present application.

### Embodiment 5

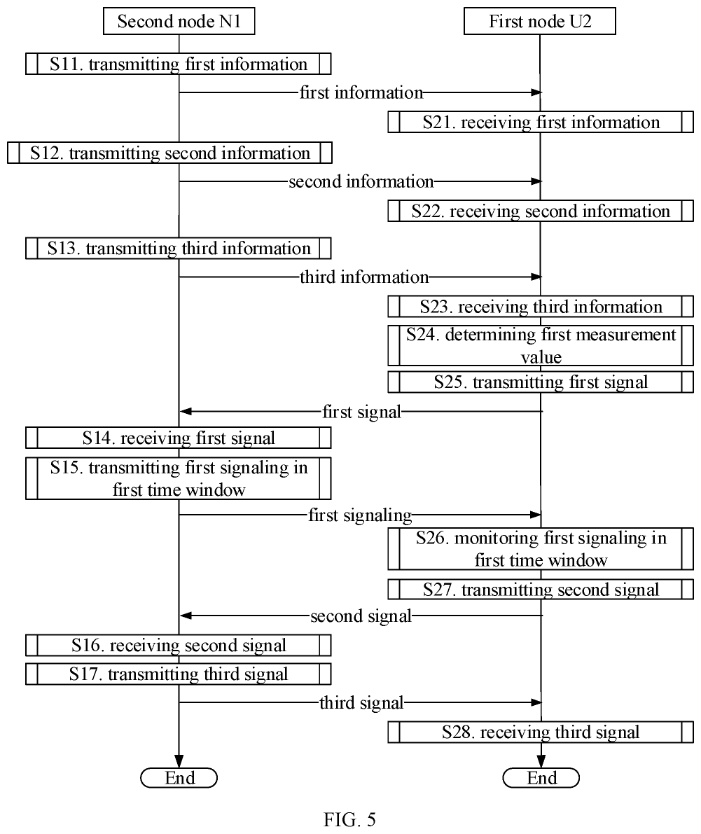

Embodiment 5 illustrates a flowchart of radio signal transmission according to one embodiment of the present application, as shown in FIG. 5. In FIG. 5, a second node N1 is a maintenance base station for a serving cell of a first node U2. It should be particularly noted that the sequence illustrated herein does not set any limit to the signal transmission order or implementation order in the present application.

The second node N1 transmits first information in step S11, transmits second information in step S12, and transmits third information in step S13, receives a first signal in step S14, transmits a first signaling in step S15, receives a second signal in step S16, and transmits a third signal in step S17.

The first node U2 receives first information in step S21, receives second information in step S22, and receives third information in step S23, determines a measurement value in step S24, transmits a first signal in step S25, and monitors a first signaling in a first time window in step S26, transmits a second signal in step S27, and receives a third signal in step S28.

In Embodiment 5, the first information in the present application is used to determine a first time length, the first time length being larger than 0; time-frequency resources occupied by the first signal in the present application are used to indicate a first identifier; the first identifier in the present application is used for monitoring the first signaling in the present application; the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access; the second information in the present application is used to determine a first integer set, the first integer set comprising a positive integer number of positive integer(s); X is equal to a positive integer comprised in the first integer set, the first measurement value in the present application is used to determine X from the first integer set; the third information in the present application is used to determine a third time length, the third time length being equal to a positive integral multiple of a duration of a characteristic period, the third time length is used to determine a time length of the first time window; when an end time of transmitting the second signal in the present application is earlier than a start time of receiving the third signal in the present application, the first time length is used to determine a time interval length between the end time of transmitting the second signal and the start time of receiving the third signal.

In one embodiment, the second information is transmitted via an air interface.

In one embodiment, the second information is transmitted via a radio interface.

In one embodiment, the second information is transmitted via a higher layer signaling.

In one embodiment, the second information is transmitted via a physical layer signaling.

In one embodiment, the second information comprises all or part of a Higher Layer signaling.

In one embodiment, the second information comprises all or part of a physical layer signaling.

In one embodiment, the second information comprises all or part of Information Elements (IEs) in a Radio Resource Control (RRC) signaling.

In one embodiment, the second information comprises all or part of fields in an Information Element (IE) in an RRC signaling.

In one embodiment, the second information comprises all or part of a Medium Access Control (MAC) layer signaling.

In one embodiment, the second information comprises all or part of a Master Information Block (MIB).

In one embodiment, the second information comprises all or part of a System Information Block (SIB).

In one embodiment, the second information comprises all or part of a System Information Block Type 1 (SIB1).

In one embodiment, the second information is transmitted through a Downlink Shared Channel (DL-SCH).

In one embodiment, the second information is transmitted through a Physical Downlink Shared Channel (PDSCH).

In one embodiment, the second information is transmitted through a Narrowband Physical Downlink Shared Channel (NPDSCH).

In one embodiment, the second information is transmitted through a Machine-type Physical Downlink Shared Channel (MPDSCH).

In one embodiment, the second information is carried by a Physical Broadcast Channel (PBCH).

In one embodiment, the second information is carried by a Narrow-band Physical Broadcast Channel (NPBCH).

In one embodiment, the second information is Cell-Specific.

In one embodiment, the second information is UE-Specific.

In one embodiment, the second information is UE group-specific.

In one embodiment, the second information is Footprint-Specific.

In one embodiment, the second information is Beam Specific.

In one embodiment, the second information is Geographical-zone-Specific.

In one embodiment, the second information comprises all or partial fields in a Downlink Control Information (DCI) signaling.

In one embodiment, the second information and the first information are respectively two different Information Elements (IEs) in a same RRC signaling.

In one embodiment, the second information and the first information are respectively two different fields in a same IE in a same RRC signaling.

In one embodiment, the second information and the first information respectively belong to two different RRC signalings.

In one embodiment, the second information belongs to an Information Element (IE) “RadioResourceConfigCommonSIB-NB”.

In one embodiment, the second information belongs to an Information Element (IE) “NPRACH-ConfigSIB-NB”.

In one embodiment, the second information belongs to an Information Element (IE) “nprach-ParametersList”.

In one embodiment, the second information belongs to an Information Element (IE) “ul-ConfigList”.

In one embodiment, the second information belongs to an Information Element (IE) “NPRACH-ParametersList-Fmt2”.

In one embodiment, the second information comprises a positive integer number of Information Elements (IEs) “Parameters-NB”.

In one embodiment, the phrase that “the second information is used to determine a first integer set” comprises the meaning that the second information is used by the first node in the present application to determine the first integer set.

In one embodiment, the phrase that “the second information is used to determine a first integer set” comprises the meaning that the second information is used for directly indicating the first integer set.

In one embodiment, the phrase that “the second information is used to determine a first integer set” comprises the meaning that the second information is used for indirectly indicating the first integer set.

In one embodiment, the phrase that “the second information is used to determine a first integer set” comprises the meaning that the second information is used for explicitly indicating the first integer set.

In one embodiment, the phrase that “the second information is used to determine a first integer set” comprises the meaning that the second information is used for implicitly indicating the first integer set.

In one embodiment, the phrase that “the second information is used to determine a first integer set” comprises the meaning that the second information comprises W sub-information-block(s), where W is a positive integer, the first integer set comprises W positive integer(s), the W sub-information-block(s) being used for (respectively) indicating the W positive integer(s).

### Embodiment 6

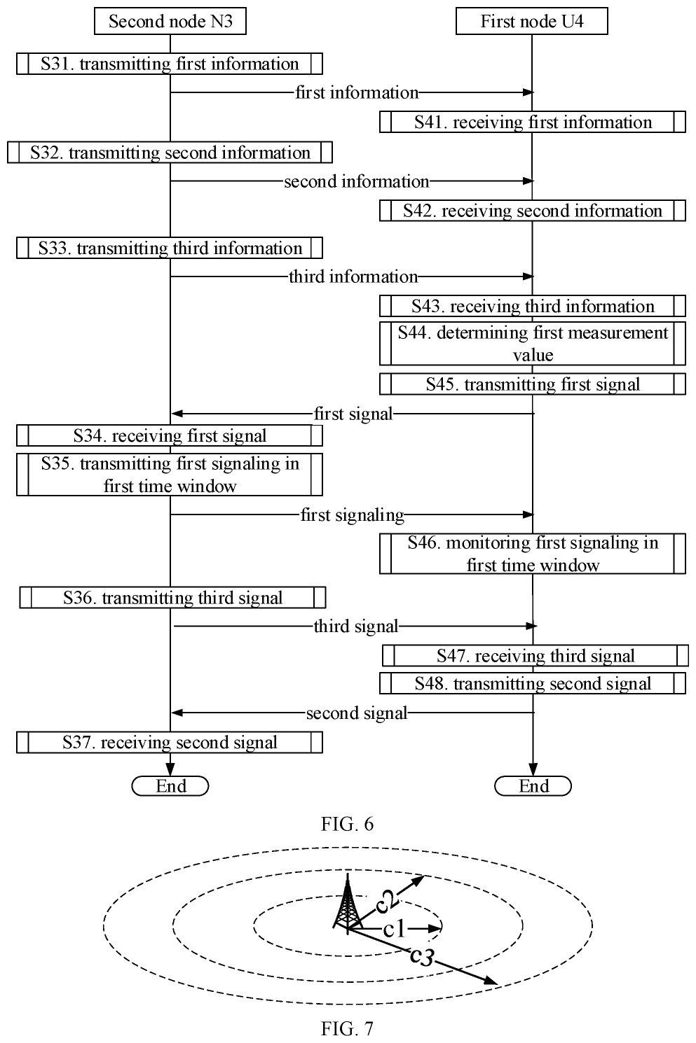

Embodiment 6 illustrates a flowchart of signal transmission according to another embodiment of the present application, as shown in FIG. 6. In FIG. 6, a second node N3 is a maintenance base station for a serving cell of a first node U4. It should be particularly noted that the sequence illustrated herein does not set any limit to the signal transmission order or implementation order in the present application.

The second node N3 transmits first information in step S31, transmits second information in step S32, and transmits third information in step S33, receives a first signal in step S34, transmits a first signaling in a first time window in step S35, transmits a third signal in step S36, and receives a second signal in step S37.

The first node U4 receives first information in step S41, receives second information in step S42, and receives third information in step S43, determines a measurement value in step S44, transmits a first signal in step S45, and monitors a first signaling in a first time window in step S46, receives a third signal in step S47, and transmits a second signal in step S48.

In Embodiment 6, the first information in the present application is used to determine a first time length, the first time length being larger than 0; time-frequency resources occupied by the first signal in the present application are used to indicate a first identifier; the first identifier in the present application is used for monitoring the first signaling in the present application; the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access; the second information in the present application is used to determine a first integer set, the first integer set comprising a positive integer number of positive integer(s); X is equal to a positive integer comprised in the first integer set, the first measurement value in the present application is used to determine X from the first integer set; the third information in the present application is used to determine a third time length, the third time length being equal to a positive integral multiple of a duration of a characteristic period, the third time length is used to determine a time length of the first time window; when a start time of transmitting the second signal is later than an end time of receiving the third signal, the first time length is used to determine a time interval length between the end time of receiving the third signal and the start time of transmitting the second signal.

In one embodiment, the third information is transmitted via an air interface.

In one embodiment, the third information is transmitted via a radio interface.

In one embodiment, the third information is transmitted via a higher layer signaling.

In one embodiment, the third information is transmitted via a physical layer signaling.

In one embodiment, the third information comprises all or part of a Higher Layer signaling.

In one embodiment, the third information comprises all or part of a physical layer signaling.

In one embodiment, the third information comprises all or part of Information Elements (IEs) in a Radio Resource Control (RRC) signaling.

In one embodiment, the third information comprises all or part of fields in an Information Element (IE) in an RRC signaling.

In one embodiment, the third information comprises all or part of a Medium Access Control (MAC) layer signaling.

In one embodiment, the third information comprises all or part of a Master Information Block (MIB).

In one embodiment, the third information comprises all or part of a System Information Block (SIB).

In one embodiment, the third information comprises all or part of a System Information Block Type 1 (SIB1).

In one embodiment, the third information is transmitted through a Downlink Shared Channel (DL-SCH).

In one embodiment, the third information is transmitted through a Physical Downlink Shared Channel (PDSCH).

In one embodiment, the third information is transmitted through a Narrowband Physical Downlink Shared Channel (NPDSCH).

In one embodiment, the third information is transmitted through a Machine-type Physical Downlink Shared Channel (MPDSCH).

In one embodiment, the third information is carried by a Physical Broadcast Channel (PBCH).

In one embodiment, the third information is carried by a Narrow-band Physical Broadcast Channel (NPBCH).

In one embodiment, the third information is Cell-Specific.

In one embodiment, the third information is UE-Specific.

In one embodiment, the third information is UE group-specific.

In one embodiment, the third information is Footprint-Specific.

In one embodiment, the third information is Beam Specific.

In one embodiment, the third information is Geographical-zone-Specific.

In one embodiment, the third information comprises all or partial fields in a Downlink Control Information (DCI) signaling.

In one embodiment, the third information and the first information are respectively two different Information Elements (IEs) in a same RRC signaling.

In one embodiment, the third information and the first information are respectively two different fields in a same IE in a same RRC signaling.

In one embodiment, the third information and the first information respectively belong to two different RRC signalings.

In one embodiment, the third information belongs to an Information Element (IE) “RadioResourceConfigCommonSIB-NB”.

In one embodiment, the third information belongs to an Information Element (IE) “RACH-ConfigCommon-NB”.

In one embodiment, the third information belongs to an Information Element (IE) “RACH-InfoList-NB”.

In one embodiment, the third information belongs to an Information Element (IE) “RACH-Info-NB”.

In one embodiment, the third information belongs to a field “ra-ResponseWindowSize” in an Information Element (IE) “RACH-Info-NB”.

In one embodiment, the third information belongs to a field “mac-ContentionResolutionTimer” in an Information Element (IE) “RACH-Info-NB”.

In one embodiment, the phrase that “the third information is used to determine a third time length” comprises the meaning that the third information is used by the first node in the present application to determine the third time length.

In one embodiment, the phrase that “the third information is used to determine a third time length” comprises the meaning that the third information is used to directly indicate the third time length.

In one embodiment, the phrase that “the third information is used to determine a third time length” comprises the meaning that the third information is used to indirectly indicate the third time length.

In one embodiment, the phrase that “the third information is used to determine a third time length” comprises the meaning that the third information is used to explicitly indicate the third time length.

In one embodiment, the phrase that “the third information is used to determine a third time length” comprises the meaning that the third information is used to implicitly indicate the third time length.

### Embodiment 7

Embodiment 7 illustrates a schematic diagram of a first integer set according to one embodiment of the present application, as shown in FIG. 7. In FIG. 7, each dotted-line circle represents the boundary of two value ranges of measurement values, “c1, c2, c3” are positive integers in a first integer set.

In Embodiment 7, the second information in the present application is used to determine a first integer set, the first integer set comprising a positive integer number of positive integer(s); X in the present application is equal to a positive integer comprised in the first integer set, the first measurement value in the present application being used to determine X from the first integer set.

In one embodiment, each integer comprised in the first integer set is a possible Number of NPRACH repetitions.

In one embodiment, each integer comprised in the first integer set is 4 times as much as a possible Number of NPRACH repetitions.

In one embodiment, each integer comprised in the first integer set is 6 times as much as a possible Number of NPRACH repetitions.

In one embodiment, each integer comprised in the first integer set is a possible Number of PRACH repetitions.

In one embodiment, each integer comprised in the first integer set is one of {1, 2, 4, 8, 16, 32, 64, 128, 256, 512, 1024}.

In one embodiment, each integer comprised in the first integer set is one of {1, 2, 4, 8, 16, 32, 64, 128}.

In one embodiment, each integer comprised in the first integer set is a product of 6 and one of {1, 2, 4, 8, 16, 32, 64, 128, 256, 512, 1024}.

In one embodiment, each integer comprised in the first integer set is a product of 6 and one of {1, 2, 4, 8, 16, 32, 64, 128}.

In one embodiment, each integer comprised in the first integer set is one of {4, 8, 16, 32, 64, 128, 256, 512, 1024, 2048, 4096}.

In one embodiment, each integer comprised in the first integer set is one of {4, 8, 16, 32, 64, 128, 256, 512}.

In one embodiment, the first integer set only comprises one positive integer.

In one embodiment, the first integer set comprises more than one positive integer.

In one embodiment, when the first integer set comprises more than one positive integer, any two positive integers in the first integer set are unequal.

In one embodiment, when the first integer set comprises more than one positive integer, the first integer set comprises two positive integers that are equal.

In one embodiment, the first measurement value is a Reference Signal Received Power (RSRP).

In one embodiment, the first measurement value is a Reference Signal Received Quality (RSRQ).

In one embodiment, the first measurement value is a Received Signal Strength Indicator (RSSI).

In one embodiment, the first measurement value is a Narrowband Reference Signal Received Power (NRSRP).

In one embodiment, the first measurement value is a Narrowband Reference Signal Received Quality (NRSRQ).

In one embodiment, the first measurement value is obtained by measuring a Reference Signal.

In one embodiment, the first measurement value is obtained by measuring a Cell-specific Reference Signal (CRS).

In one embodiment, the first measurement value is obtained by measuring a Narrowband Reference Signal (NRS).

In one embodiment, the phrase of “the first measurement value being used to determine X from the first integer set” comprises the meaning that the first measurement value is used by the first node in the present application to determine X from the first integer set.

In one embodiment, the phrase of “the first measurement value being used to determine X from the first integer set” comprises the meaning that the first measurement value is used for indirectly determining X from the first integer set.

In one embodiment, the phrase of “the first measurement value being used to determine X from the first integer set” comprises the meaning that the first measurement value is used for directly determining X from the first integer set.

In one embodiment, the phrase of “the first measurement value being used to determine X from the first integer set” comprises the meaning that the first measurement value is used to determine an Enhanced Coverage Level of the first node, which in turn is used to determine X from the first integer set.

In one embodiment, the phrase of “the first measurement value being used to determine X from the first integer set” comprises the meaning that W Enhanced Coverage Levels respectively correspond to W positive integers in the first integer set, where W is a positive integer; an Enhanced Coverage Level of the first node is one of the W Enhanced Coverage Levels, the first measurement value is used to determine the Enhanced Coverage Level of the first node out of the W Enhanced Coverage Levels, X being equal to a positive integer corresponding to the Enhanced Coverage Level of the first node in the first integer set.

In one embodiment, the second receiver receives a fourth signal; herein, the fourth signal carries a Random Access Response (RAR), or the fourth signal carries an MsgB; the first signaling is used to indicate time-frequency resources occupied by the fourth signal.

### Embodiment 8

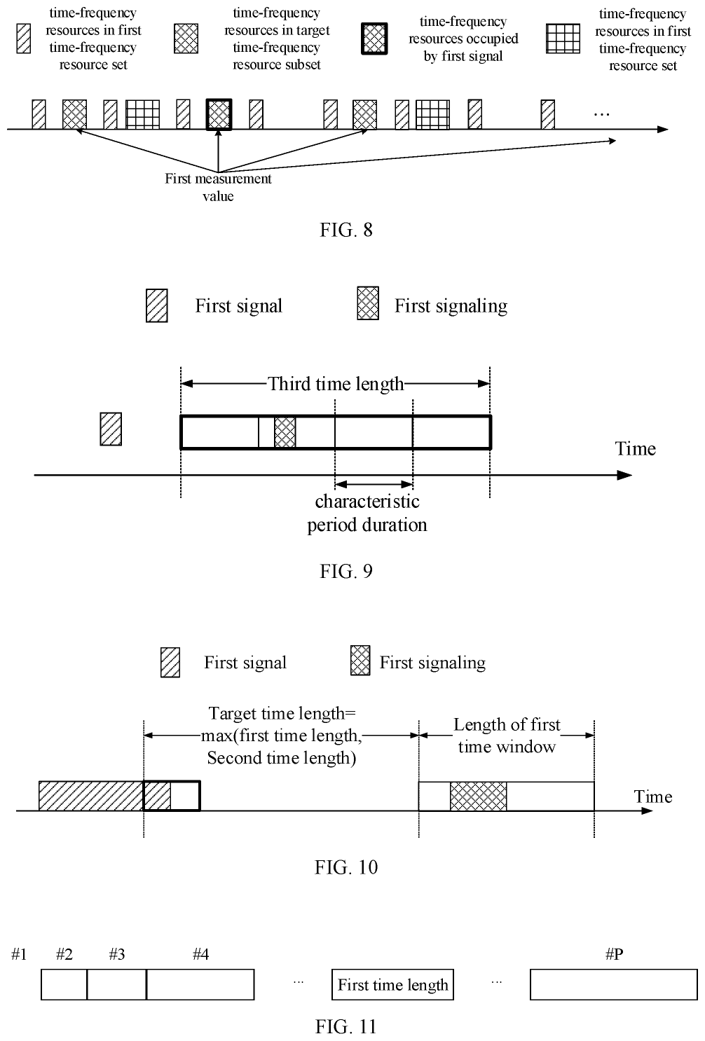

Embodiment 8 illustrates a schematic diagram of a relation between a first measurement value and a target time-frequency resource subset according to one embodiment of the present application, as shown in FIG. 8. In FIG. 8, each rectangle represents a time-frequency resource in a first time-frequency resource set, rectangles with the same filling represent time-frequency resources belonging to a same time-frequency resource subset in the first time-frequency resource set, time-frequency resources represented by cross-filled rectangles belong to a target time-frequency resource subset, the cross-filled rectangle framed with thick lines represents time-frequency resources occupied by the first signal.

In Embodiment 8, the second information in the present application is used to determine a first time-frequency resource set, the first time-frequency resource set comprising a positive integer number of time-frequency resource subset(s), time-frequency resources occupied by the first signal in the present application belong to a target time-frequency resource subset, the target time-frequency resource subset being a time-frequency resource subset comprised in the first time-frequency resource set; the first measurement value in the present application is used to determine the target time-frequency resource subset from the first time-frequency resource set, the first node in the present application randomly selects time-frequency resources occupied by the first signal in the target time-frequency resource subset.

In one embodiment, the phrase that “the second information is used to determine a first time-frequency resource set” comprises the meaning that the second information is used by the first node in the present application to determine the first time-frequency resource set.

In one embodiment, the phrase that “the second information is used to determine a first time-frequency resource set” comprises the meaning that the second information is used for directly indicating the first time-frequency resource set.

In one embodiment, the phrase that “the second information is used to determine a first time-frequency resource set” comprises the meaning that the second information is used for indirectly indicating the first time-frequency resource set.

In one embodiment, the phrase that “the second information is used to determine a first time-frequency resource set” comprises the meaning that the second information is used for explicitly indicating the first time-frequency resource set.

In one embodiment, the phrase that “the second information is used to determine a first time-frequency resource set” comprises the meaning that the second information is used for implicitly indicating the first time-frequency resource set.

In one embodiment, the phrase that “the second information is used to determine a first time-frequency resource set” comprises the meaning that the second information comprises W1 sub-information-block(s), where W1 is a positive integer, the first time-frequency resource set comprises W1 time-frequency resource subset(s), the W1 sub-information-block(s) being used for (respectively) indicating the W1 time-frequency resource subset(s).

In one embodiment, the phrase that “the second information is used to determine a first time-frequency resource set” comprises the meaning that the second information comprises W1 sub-information-block(s), where W1 is a positive integer, the first time-frequency resource set comprises W1 time-frequency resource subset(s), the W1 sub-information-block(s) being used for (respectively) indicating start time(s) for the W1 time-frequency resource subset(s), the W1 sub-information-block(s) being used for (respectively) indicating subcarrier offset(s) of the W1 time-frequency resource subset(s), and the W1 sub-information-block(s) being used for (respectively) indicating period(s) of the W1 time-frequency resource subset(s).

In one embodiment, each time-frequency resource subset comprised in the first time-frequency resource set is time-frequency resource(s) that can be used for a PRACH transmission.

In one embodiment, each time-frequency resource subset comprised in the first time-frequency resource set is time-frequency resource(s) that can be used for an NPRACH transmission.

In one embodiment, each time-frequency resource subset comprised in the first time-frequency resource set is time-frequency resource(s) occupied by a Random Access Occasion (RO).

In one embodiment, each time-frequency resource subset comprised in the first time-frequency resource set comprises a positive integer number of candidate time-frequency resource block(s), where each candidate time-frequency resource block in the first time-frequency resource set is time-frequency resource(s) that can be used for an NPRACH transmission.

In one embodiment, the phrase that “the first measurement value is used to determine the target time-frequency resource subset from the first time-frequency resource set” comprises the meaning that the first measurement value is used by the first node in the present application to determine the target time-frequency resource subset from the first time-frequency resource set.

In one embodiment, the phrase that “the first measurement value is used to determine the target time-frequency resource subset from the first time-frequency resource set” comprises the meaning that the first measurement value is used to directly determine the target time-frequency resource subset from the first time-frequency resource set.

In one embodiment, the phrase that “the first measurement value is used to determine the target time-frequency resource subset from the first time-frequency resource set” comprises the meaning that the first measurement value is used to indirectly determine the target time-frequency resource subset from the first time-frequency resource set.

In one embodiment, the phrase of “the first measurement value being used to determine the target time-frequency resource subset from the first time-frequency resource set” comprises the meaning that the first measurement value is used to determine an Enhanced Coverage Level of the first node, which in turn is used to determine the target time-frequency resource subset from the first time-frequency resource set.

In one embodiment, the phrase of “the first measurement value being used to determine the target time-frequency resource subset from the first time-frequency resource set” comprises the meaning that W1 Enhanced Coverage Levels respectively correspond to W1 time-frequency resource subsets in the first time-frequency resource set, where W1 is a positive integer; an Enhanced Coverage Level of the first node is one of the W1 Enhanced Coverage Levels, the first measurement value is used to determine the Enhanced Coverage Level of the first node out of the W1 Enhanced Coverage Levels, the target time-frequency resource subset being a time-frequency resource subset corresponding to the Enhanced Coverage Level of the first node in the first time-frequency resource set.

In one embodiment, the phrase that “the first node randomly selects time-frequency resources occupied by the first signal in the target time-frequency resource subset” comprises a meaning that the first node randomly selects time-frequency resources occupied by the first signal with equal probability in the target time-frequency resource subset.

In one embodiment, the phrase that “the first node randomly selects time-frequency resources occupied by the first signal in the target time-frequency resource subset” comprises a meaning that the first node randomly selects time-frequency resources occupied by the first signal without equal probability in the target time-frequency resource subset.

In one embodiment, the phrase that “the first node autonomously selects time-frequency resources occupied by the first signal in the target time-frequency resource subset” comprises a meaning that the first node autonomously selects time-frequency resources occupied by the first signal according to prioritization in the target time-frequency resource subset.

In one embodiment, the phrase that “the first node autonomously selects time-frequency resources occupied by the first signal in the target time-frequency resource subset” comprises a meaning that the first node randomly selects time-frequency resources occupied by the first signal according to probability distribution in the target time-frequency resource subset.

In one embodiment, the phrase that “the first node autonomously selects time-frequency resources occupied by the first signal in the target time-frequency resource subset” comprises a meaning that the target time-frequency resource subset comprises Y1 candidate time-frequency resource blocks, Y1 being a positive integer, the first signal occupies one of the Y1 candidate time-frequency resource blocks, the first node randomly selects the candidate time-frequency resource block occupied by the first signal from the Y1 candidate time-frequency resource blocks.

In one embodiment, time-frequency resources comprised in the target time-frequency resource subset belong to a same Carrier.

In one embodiment, time-frequency resources comprised in the target time-frequency resource subset belong to an Anchor Carrier.

In one embodiment, there are two time-frequency resource blocks in the target time-frequency resource subset that belong to two different Carriers.

In one embodiment, there is a time-frequency resource block in the target time-frequency resource subset that belongs to an Anchor Carrier, and there is a time-frequency resource block in the target time-frequency resource subset that belongs to a Non-anchor Carrier.

In one embodiment, the first receiver receives fourth information; herein, the fourth information is used to determine P1 measurement threshold(s), where P1 is a positive integer, the P1 measurement threshold(s) is(are) used to determine P2 measurement ranges, where P2 is equal to P1 plus 1; the P2 measurement ranges respectively correspond to P2 Enhanced Coverage Levels, the first measurement value belongs to a measurement range among the P2 measurement ranges, an Enhanced Coverage Level of the first node is one of the P2 Enhanced Coverage Levels corresponding to a measurement range to which the first measurement value belongs.

### Embodiment 9

Embodiment 9 illustrates a schematic diagram of a third time length according to one embodiment of the present application, as shown in FIG. 9. In FIG. 9, the horizontal axis represents time, the slash-filled rectangle represents a first signal, and the cross-filled rectangle represents a first signaling, and the rectangle with a thick-line frame represents a first time window.

In Embodiment 9, the third information in the present application is used to determine a third time length, the third time length being equal to a positive integral multiple of a duration of a characteristic period; the third time length is equal to a time length of the first time window in the present application.

In one embodiment, the third time length is related to the first time length.

In one embodiment, the third time length is unrelated to the first time length.

In one embodiment, the first information and the third information are jointly used to determine the third time length.

In one embodiment, the third time length is unrelated to the first information.

In one embodiment, the third time length is one of Random Access Response (RAR) Window lengths that can be supported by a UE in NB-IoT in R16.

In one embodiment, the third time length can be larger than a maximum Random Access Response (RAR) Window length that can be supported by a UE in NB-IoT in R16.

In one embodiment, the third time length is a Random Access Response (RAR) Window length.

In one embodiment, the third time length is equal to Q1 times the length of a characteristic period, where Q1 is one of {2, 3, 4, 5, 6, 7, 8, 10}.

In one embodiment, the third time length is equal to Q1 times the length of a characteristic period, where Q1 is a positive integer greater than 10.

In one embodiment, the third time length is equal to Q1 times the length of a characteristic period, where Q1 belongs to a second integer set, the second integer set comprising a positive integer number of positive integers, there being a positive integer greater than 10 in the second integer set.

In one embodiment, the third time length is equal to Q1 times the length of a characteristic period, where Q1 belongs to a second integer set, the second integer set comprising a positive integer number of positive integers, there being a positive integer not belonging to {2, 3, 4, 5, 6, 7, 8, 10} in the second integer set.

In one embodiment, the first receiver receives fourth information; herein, the fourth information is used to determine the characteristic period, i.e., PDCCH Period (PP).

In one embodiment, the characteristic period is a Physical Downlink Control CHannel (PDCCH) Period (i.e., PP).

In one embodiment, the characteristic period is a Narrowband Physical Downlink Control CHannel (NPDCCH) Period.

In one embodiment, the characteristic period is pre-defined.

In one embodiment, the characteristic period is configurable.

In one embodiment, the characteristic period is a time interval between start times for two consecutive PDCCH Occasions.

In one embodiment, the characteristic period is a time interval between start times for two consecutive NPDCCH Occasions.

In one embodiment, configurations for a PDCCH search space are used to determine the characteristic period.

In one embodiment, configurations for an NPDCCH search space are used to determine the characteristic period.

In one embodiment, configurations for an MPDCCH search space are used to determine the characteristic period.

In one embodiment, the phrase that “the “the third time length is used to determine a time length of the first time window” comprises the meaning that the third time length is used by the first node in the present application to determine a time length of the first time window.

In one embodiment, the phrase that “the “the third time length is used to determine a time length of the first time window” comprises the meaning that a smaller value of the third time length and a first threshold is equal to a time length of the first time window, the first threshold being pre-defined.

In one embodiment, the phrase that “the “the third time length is used to determine a time length of the first time window” comprises the meaning that a smaller value of the third time length and a first threshold is equal to a time length of the first time window, the first threshold being fixed.

In one embodiment, the phrase that “the “the third time length is used to determine a time length of the first time window” comprises the meaning that a smaller value of the third time length and a first threshold is equal to a time length of the first time window, the first threshold being equal to 10.24s.

In one embodiment, the phrase that “the “the third time length is used to determine a time length of the first time window” comprises the meaning that a smaller value of the third time length and a first threshold is equal to a time length of the first time window, the first threshold being equal to 20.48s.

In one embodiment, the phrase that “the “the third time length is used to determine a time length of the first time window” comprises the meaning that a smaller value of the third time length and a first threshold is equal to a time length of the first time window, the first threshold being related to a duplex mode of a Band where a carrier to which the first signal belongs in frequency domain is present.

In one embodiment, the phrase that “the “the third time length is used to determine a time length of the first time window” comprises the meaning that the third time length is equal to a time length of the first time window.

### Embodiment 10

Embodiment 10 illustrates a schematic diagram of a target time length according to one embodiment of the present application, as shown in FIG. 10. In FIG. 10, the horizontal axis represents time, the slash-filled rectangle represents a first signal, and the cross-filled rectangle represents a first signaling, the rectangle without filling which comprises the first signaling represents a first time window, and the blank rectangle with a thick-line frame represents a time-domain resource unit comprising an end of the first signal.

In Embodiment 10, a larger value of the first time length in the present application and the second time length in the present application is used to determine a target time length, the target time length being used to determine a length of a time interval between a start of the first time window in the present application and an end time of transmitting the first signal in the present application.

In one embodiment, the phrase that “a larger value of the first time length and the second time length is used to determine a target time length” comprises a meaning that a larger value of the first time length and the second time length is used by the first node in the present application to determine the target time length

In one embodiment, the phrase that “a larger value of the first time length and the second time length is used to determine a target time length” comprises a meaning that the target time length is equal to a larger value of the first time length and the second time length.

In one embodiment, the phrase that “a larger value of the first time length and the second time length is used to determine a target time length” comprises a meaning that the target time length is linear with a larger value of the first time length and the second time length.

In one embodiment, the phrase that “a larger value of the first time length and the second time length is used to determine a target time length” comprises a meaning that a larger value of the first time length and the second time length, after being through functional operation, determines the target time length.

In one embodiment, the phrase that “a larger value of the first time length and the second time length is used to determine a target time length” comprises a meaning that a larger value of the first time length and the second time length, according to a mapping relationship, determines the target time length.

In one embodiment, the target time length is measured in milliseconds (ms).

In one embodiment, the target time length is measured in seconds (s).

In one embodiment, the target time length is expressed in a number of PDCCH Periods (PPs).

In one embodiment, the target time length is expressed in a number of Orthogonal Frequency Division Multiplexing (OFDM) Symbols.

In one embodiment, the target time length is expressed in a number of subframes.

In one embodiment, the phrase of “the target time length being used to determine a length of a time interval between a start of the first time window and an end time of transmitting the first signal” comprises a meaning that the target time length is equal to a length of a time interval between a start of the first time window and an end time of transmitting the first signal.

In one embodiment, the phrase of “the target time length being used to determine a length of a time interval between a start of the first time window and an end time of transmitting the first signal” comprises a meaning that the target time length is equal to a length of a time interval between a start of the first time window and a start time of a subframe comprising an end of transmission of the first signal.

In one embodiment, the phrase of “the target time length being used to determine a length of a time interval between a start of the first time window and an end time of transmitting the first signal” comprises a meaning that the target time length is equal to a length of a time interval between a start of the first time window and an end time of a subframe comprising an end of transmission of the first signal.

In one embodiment, the phrase of “the target time length being used to determine a length of a time interval between a start of the first time window and an end time of transmitting the first signal” comprises a meaning that the target time length is equal to a length of a time interval between a start of the first time window and a start time of a subframe comprising an end of a latest repetition of the first signal.

In one embodiment, the phrase of “the target time length being used to determine a length of a time interval between a start of the first time window and an end time of transmitting the first signal” comprises a meaning that the target time length is equal to a length of a time interval between a start of the first time window and an end time of a subframe comprising an end of a latest repetition of the first signal.

In one embodiment, the phrase of “the target time length being used to determine a length of a time interval between a start of the first time window and an end time of transmitting the first signal” comprises a meaning that the target time length is equal to a length of a time interval between a start of the first time window and a start time of a first subframe, the first subframe comprising an OFDM symbol occupied by the first signal.

In one embodiment, the phrase of “the target time length being used to determine a length of a time interval between a start of the first time window and an end time of transmitting the first signal” comprises a meaning that the target time length is equal to a length of a time interval between a start of the first time window and a start time of a first subframe, the first subframe being a downlink subframe with a same subframe index as an uplink subframe to which a last OFDM symbol occupied by the first signal belongs.

In one embodiment, the phrase of “the target time length being used to determine a length of a time interval between a start of the first time window and an end time of transmitting the first signal” comprises a meaning that a start of the first time window is a start time of an earliest PDCCH Occasion between which and a start time of a first subframe there is a time interval length no smaller than the target time length, where the first subframe is a subframe comprising an end of a latest repetition of the first signal.

In one embodiment, the phrase of “the target time length being used to determine a length of a time interval between a start of the first time window and an end time of transmitting the first signal” comprises a meaning that a start of the first time window is a start time of an earliest NPDCCH Occasion between which and a start time of a first subframe there is a time interval length no smaller than the target time length, where the first subframe is a subframe comprising an end of a latest repetition of the first signal.

### Embodiment 11

Embodiment 11 illustrates a schematic diagram of P candidate time lengths according to one embodiment of the present application, as shown in FIG. 11. In FIG. 11, each rectangle represents a candidate time length among the P candidate time lengths.

In Embodiment 11, the first time length is equal to one of P candidate time lengths, where P is a positive integer greater than 1, the first information is used to determine the first time length out of the P candidate time lengths; the P candidate time lengths are pre-defined, and there is a candidate time length equal to 0 among the P candidate time lengths.

In one embodiment, the P candidate time lengths are related to a possible type of a transmitter for the first information in the present application.

In one embodiment, the P candidate time lengths are related to a possible type of a satellite to which a transmitter for the first information in the present application belongs.

In one embodiment, the P candidate time lengths are related to a possible distance between a transmitter for the first information in the present application and the Nadir.

In one embodiment, any of the P candidate time lengths is no smaller than 0.

In one embodiment, any two candidate time lengths among the P candidate time lengths are unequal.

In one embodiment, there are two candidate time lengths being equal among the P candidate time lengths.

In one embodiment, the phrase that “the first information is used to determine the first time length out of the P candidate time lengths” in the present application comprises the meaning that the first information is used to directly indicate the first time length out of the P candidate time lengths.

In one embodiment, the phrase that “the first information is used to determine the first time length out of the P candidate time lengths” in the present application comprises the meaning that the first information is used to implicitly indicate the first time length out of the P candidate time lengths.

In one embodiment, the phrase that “the first information is used to determine the first time length out of the P candidate time lengths” in the present application comprises the meaning that the first information is used to indirectly indicate the first time length out of the P candidate time lengths.

In one embodiment, the phrase that “the P candidate time lengths are pre-defined” comprises the meaning that the P candidate time lengths are fixed.

In one embodiment, the phrase that “the P candidate time lengths are pre-defined” comprises the meaning that the P candidate time lengths are predefined based on versions of releases.

In one embodiment, the phrase that “the P candidate time lengths are pre-defined” comprises the meaning that the P candidate time lengths are predefined based on presence in NTN.

In one embodiment, the phrase that “the P candidate time lengths are pre-defined” comprises the meaning that the P candidate time lengths are predefined based on whether more than one candidate time length is supported.

In one embodiment, the phrase that “the P candidate time lengths are pre-defined” comprises the meaning that the P candidate time lengths are hard-coded in the Specification.

### Embodiment 12

Embodiment 12 illustrates a schematic diagram of a relation between a first value range and a second time length according to one embodiment of the present application, as shown in FIG. 12. In FIG. 12, the first column on the left represents possible formats of preamble sequence, the second column represents possible candidate value ranges and the third column represent possible candidate time lengths, the format of preamble sequence, the candidate value range and the candidate time length in a row in bold respectively correspond to a format of a preamble sequence carried by the first signal, a first value range and a second time length.

In Embodiment 12, X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

In one embodiment, any of the M candidate value ranges is a value range of integers.

In one embodiment, any of the M candidate value ranges is a range of numbers of NRPACH repetitions.

In one embodiment, any of the M candidate value ranges is a set of integers.

In one embodiment, any two candidate value ranges among the M candidate value ranges are non-overlapped.

In one embodiment, any two candidate value ranges among the M candidate value ranges are orthogonal.

In one embodiment, the M candidate value ranges cover all positive integers.

In one embodiment, M is equal to 2.

In one embodiment, M is greater than 2.

In one embodiment, M is equal to 2, the M candidate value ranges respectively being [16, ∞) and (0,16).

In one embodiment, M is equal to 2, the M candidate value ranges respectively being [64, ∞) and (0,64).

In one embodiment, M is equal to 2, the M candidate value ranges respectively being “>=16” and “<16”.

In one embodiment, M is equal to 2, the M candidate value ranges respectively being “>=64” and “<64”.

In one embodiment, a format of a preamble sequence carried by the first signal comprises a length of a cyclic prefix in the first signal and a time length occupied by the preamble sequence.

In one embodiment, a format of a preamble sequence carried by the first signal is used to determine a length of a cyclic prefix in the first signal and a time length occupied by the preamble sequence.

In one embodiment, a format of a preamble sequence carried by the first signal is used to determine a length of a cyclic prefix in the first signal, a time length occupied by the preamble sequence, a number of symbol groups comprised in a preamble repetition unit in the first signal and a number of time-domain consecutive symbol groups.

In one embodiment, a format of a preamble sequence carried by the first signal is one of a Preamble Format 0, a Preamble Format 1 or a Preamble Format 2.

In one embodiment, a format of a preamble sequence carried by the first signal is one of a Preamble Format 0, a Preamble Format 1, a Preamble Format 2, a Preamble Format 0-a or a Preamble Format 1-a.

In one embodiment, the first information in the present application is used to determine a format of a preamble sequence carried by the first signal.

In one embodiment, the second information in the present application is used to determine a format of a preamble sequence carried by the first signal.

In one embodiment, the second information in the present application is used to determine a CP length in the first signal, the CP length in the first signal being used to determine a format of a preamble sequence carried by the first signal.

In one embodiment, the phrase that “a format of a preamble sequence carried by the first signal is used to determine the M candidate value ranges” comprises a meaning that a format of a preamble sequence carried by the first signal is used by the first node in the present application to determine the M candidate value ranges.

In one embodiment, the phrase that “a format of a preamble sequence carried by the first signal is used to determine the M candidate value ranges” comprises a meaning that a format of a preamble sequence carried by the first signal is used to determine the M candidate value ranges according to a corresponding relationship.

In one embodiment, the phrase that “a format of a preamble sequence carried by the first signal is used to determine the M candidate value ranges” comprises a meaning that a format of a preamble sequence carried by the first signal is used to determine the M candidate value ranges according to a table-based mapping relationship.

In one embodiment, a duplex mode (FDD or TDD) of a Band where a Carrier to which frequency-domain resources occupied by the first signal belong is present is used to determine the M candidate value ranges.

In one embodiment, any of the M candidate time lengths is larger than 0.

In one embodiment, there is a candidate time length among the M candidate time lengths being equal to 0.

In one embodiment, any two candidate time lengths among the M candidate time lengths are unequal.

In one embodiment, there are two candidate time lengths being equal among the M candidate time lengths.

In one embodiment, M is equal to 2, the M candidate time lengths respectively being 41 ms and 4 ms.

In one embodiment, M is equal to 2, the M candidate time lengths respectively being a time length of 41 subframes and a time length of 4 subframes.

In one embodiment, any of the M candidate time lengths is measured in milliseconds (ms).

In one embodiment, any of the M candidate time lengths is measured in seconds (s).

In one embodiment, any of the M candidate time lengths is expressed in a number of PDCCH Periods (PPs).

In one embodiment, any of the M candidate time lengths is expressed in a number of Orthogonal Frequency Division Multiplexing (OFDM) Symbols.

In one embodiment, any of the M candidate time lengths is expressed in a number of subframes.

In one embodiment, a one-to-one correspondence relationship between the M candidate value ranges and the M candidate time lengths is fixed.

In one embodiment, a one-to-one correspondence relationship between the M candidate value ranges and the M candidate time lengths is pre-defined.

In one embodiment, a one-to-one correspondence relationship between the M candidate value ranges and the M candidate time lengths is configurable.

### Embodiment 13

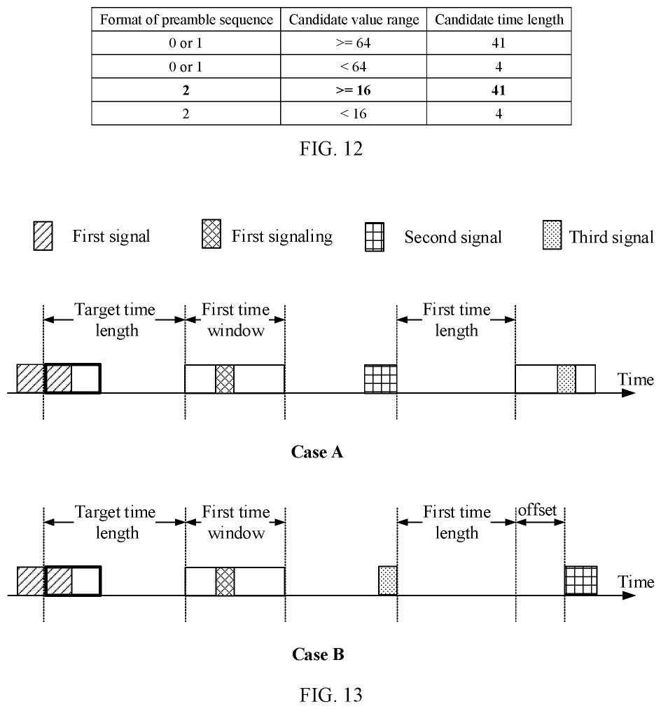

Embodiment 13 illustrates a schematic diagram of a relation between a second signal and a third signal according to one embodiment of the present application, as shown in FIG. 13. In FIG. 13, the horizontal axis represents time, the slash-filled rectangle represents a first signal, the cross-filled rectangle represents a first signaling, the reticle-filled rectangle represents a second signal, and the dot-filled rectangle represents a third signal; in Case A, an end time of transmitting the second signal is earlier than a start time of receiving the third signal, a blank rectangle to which the third signal belongs represents a time window for monitoring the third signal; in Case B, a start time of transmitting the second signal is later than an end time of receiving the third signal; where an offset value is determined by the third signal or is known before receiving the third signal.

In Embodiment 13, when an end time of transmitting the second signal in the present application is earlier than a start time of receiving the third signal in the present application, the first time length in the present application is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.

In one embodiment, the second signal and the first signal are different.

In one embodiment, the second signal is transmitted via an air interface.

In one embodiment, the second signal is transmitted via a radio interface.

In one embodiment, the second signal is a Baseband Signal.

In one embodiment, the second signal is a Radio Frequency (RF) signal.

In one embodiment, the second signal is transmitted through an Uplink Shared Channel (UL-SCH).

In one embodiment, the second signal is transmitted through a Physical Uplink Shared Channel (PUSCH).

In one embodiment, the second signal is transmitted through a Narrowband Physical Uplink Shared Channel (NPUSCH).

In one embodiment, the second signal is transmitted using a Narrowband Physical Uplink Shared Channel (NPUSCH) format 1.

In one embodiment, the second signal is transmitted using a Narrowband Physical Uplink Shared Channel (NPUSCH) format 2.

In one embodiment, the second signal is transmitted through a Machine-type Physical Uplink Shared Channel (MPUSCH).

In one embodiment, the second signal is transmitted through a Physical Uplink Control Channel (PUCCH).

In one embodiment, the second signal carries an MsgA.

In one embodiment, the second signal carries an Msg3.

In one embodiment, the second signal is scheduled by a signal scheduled by the first signaling.

In one embodiment, the second signal is scheduled by a Random Access Response (RAR).

In one embodiment, the second signal is scheduled by a UL Grant in a Random Access Response (RAR).

In one embodiment, the second signal is scheduled by an MsgB.

In one embodiment, the second signal is scheduled by a UL Grant in a Fallback RAR in an MsgB.

In one embodiment, the second signal carries Uplink control information (UCI).

In one embodiment, the second signal carries an ACK/a NACK.

In one embodiment, the second signal carries Channel Status Information (CSI).

In one embodiment, the second signal is transmitted through PUSCH Piggyback.

In one embodiment, the second signal is used for carrying a Transport Block (TB).

In one embodiment, the third signal is transmitted via an air interface.

In one embodiment, the third signal is transmitted via a radio interface.

In one embodiment, the third signal is a Baseband Signal.

In one embodiment, the third signal is a Radio Frequency (RF) signal.

In one embodiment, the third signal carries a physical layer signaling.

In one embodiment, the third signal is transmitted through a Narrowband Physical Downlink Control Channel (NPDCCH).

In one embodiment, the third signal is transmitted through a Machine-type Physical Downlink Control Channel (MPDCCH).

In one embodiment, the third signal is transmitted through a Physical Downlink Control Channel (PDCCH).

In one embodiment, the third signal carries all or partial fields in Downlink Control Information (DCI).

In one embodiment, the third signal comprises all or partial fields in Downlink Control Information (DCI) with a given DCI format.

In one embodiment, the third signal carries an Uplink Grant in a Random Access Response (RAR).

In one embodiment, the third signal carries an Uplink Grant in a Fallback RAR in an MsgB.

In one embodiment, the third signal carries an MsgB.

In one embodiment, the third signal carries an Msg4.

In one embodiment, the third signal carries DCI scheduling an MsgB.

In one embodiment, the third signal carries DCI scheduling an Msg4.

In one embodiment, the third signal is a Channel Status Information Reference Signal (CSI-RS).

In one embodiment, the third signal is transmitted through a Downlink Shared Channel (DL-SCH).

In one embodiment, the third signal is transmitted through a Physical Downlink Shared Channel (PDSCH).

In one embodiment, the third signal is transmitted through a Narrowband Physical Downlink Shared Channel (NPDSCH).

In one embodiment, the third signal is transmitted through a Machine-type Physical Downlink Shared Channel (MPDSCH).

In one embodiment, the third signal is used for carrying a Transport Block (TB).

In one embodiment, when a start time of transmitting the second signal is later than an end time of receiving the third signal, the first signaling in the present application is used to determine time-frequency resources occupied by the third signal.

In one embodiment, when a start time of transmitting the second signal is later than an end time of receiving the third signal, the first signaling in the present application is used to determine a Modulation Coding Scheme (MCS) used by the third signal.

In one embodiment, when a start time of transmitting the second signal is later than an end time of receiving the third signal, the third signal is used to determine time-frequency resources occupied by the second signal.

In one embodiment, when a start time of transmitting the second signal is later than an end time of receiving the third signal, the third signal is used to determine an MCS used by the second signal.

In one embodiment, when a start time of transmitting the second signal is later than an end time of receiving the third signal, the third signal is used for reference of Channel Status Information (CSI) carried by the second signal.

In one embodiment, when a start time of transmitting the second signal is later than an end time of receiving the third signal, the second signal is used to indicate whether the third signal is correctly received.

In one embodiment, when a start time of transmitting the second signal is later than an end time of receiving the third signal, the second signal is used for carrying an ACK/a NACK for the third signal.

In one embodiment, the phrase that “the first time length is used to determine a time interval length between the end time of transmitting the second signal and the start time of receiving the third signal” comprises a meaning that the second signal carries an Msg3, while the third signal is used to schedule an Msg4, the first time length is used to determine a start of time counting of a Contention resolution timer.

In one embodiment, the phrase that “the first time length is used to determine a time interval length between the end time of transmitting the second signal and the start time of receiving the third signal” comprises a meaning that the first time length is used by the first node in the present application to determine a time interval length between the end time of transmitting the second signal and the start time of receiving the third signal.

In one embodiment, the phrase that “the first time length is used to determine a time interval length between the end time of transmitting the second signal and the start time of receiving the third signal” comprises a meaning that the second signal carries an MsgA, while the third signal is used to schedule an MsgB, the first time length is used to determine a start of an MsgB Response Window, the first signal and the second signal respectively belonging to two random access procedures.

In one embodiment, the phrase that “the first time length is used to determine a time interval length between the end time of transmitting the second signal and the start time of receiving the third signal” comprises a meaning that the second signal carries an MsgA, while the third signal is used to schedule an MsgB, the first time length is used to determine a start of an MsgB Response Window, the first signal and the second signal respectively belonging to different types of random access procedures.

In one embodiment, the phrase that “the first time length is used to determine a time interval length between the end time of transmitting the second signal and the start time of receiving the third signal” comprises a meaning that time-domain resources occupied by the third signal belong to a second time window, the first time length is used to determine a time interval length between a start of the second time window and an end time of transmitting the second signal, the second time window being different from the first time window.

In one embodiment, the phrase that “the first time length is used to determine a time interval length between the end time of transmitting the second signal and the start time of receiving the third signal” comprises a meaning that the first time length is used to determine a lower limit of a time interval length between the end time of transmitting the second signal and the start time of receiving the third signal.

In one embodiment, the phrase that “the first time length is used to determine a time interval length between the end time of transmitting the second signal and the start time of receiving the third signal” comprises a meaning that the first time length is equal to a time interval length between the end time of transmitting the second signal and the start time of receiving the third signal.

In one embodiment, the phrase that “the first time length is used to determine a time interval length between the end time of transmitting the second signal and the start time of receiving the third signal” comprises a meaning that the first time length is no larger than a time interval length between the end time of transmitting the second signal and the start time of receiving the third signal.

In one embodiment, the phrase that “the first time length is used to determine a time interval length between the end time of receiving the third signal and the start time of transmitting the second signal” comprises a meaning that the first time length is used by the first node in the present application to determine a time interval length between the end time of receiving the third signal and the start time of transmitting the second signal.

In one embodiment, the phrase that “the first time length is used to determine a time interval length between the end time of receiving the third signal and the start time of transmitting the second signal” comprises a meaning that the third signal is used to determine a scheduling delay, and the third signal is used to determine frequency-domain resources occupied by the second signal, a sum of the first time length and the scheduling delay is used to determine a time interval length between the end time of receiving the third signal and the start time of transmitting the second signal.

In one embodiment, the phrase that “the first time length is used to determine a time interval length between the end time of receiving the third signal and the start time of transmitting the second signal” comprises a meaning that the first time length is equal to a lower limit of a time interval length between the end time of receiving the third signal and the start time of transmitting the second signal.

In one embodiment, the phrase that “the first time length is used to determine a time interval length between the end time of receiving the third signal and the start time of transmitting the second signal” comprises a meaning that the first time length is no larger than a lower limit of a time interval length between the end time of receiving the third signal and the start time of transmitting the second signal.

In one embodiment, the phrase that “the first time length is used to determine a time interval length between the end time of receiving the third signal and the start time of transmitting the second signal” comprises a meaning that a scheduling signaling for scheduling the third signal is used to indicate a feedback delay, and the second signal is used to indicate whether the third signal is correctly received; a sum of the first time length and the feedback delay is used to determine a time interval length between the end time of receiving the third signal and the start time of transmitting the second signal.

### Embodiment 14

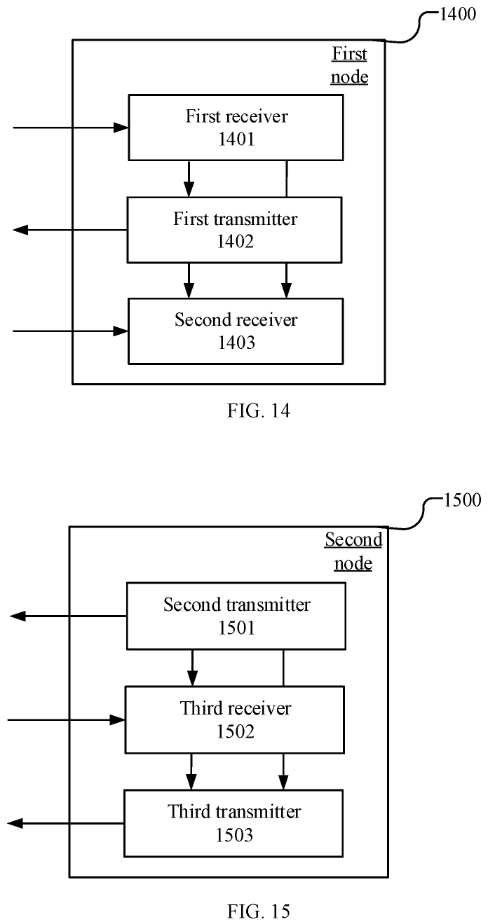

Embodiment 14 illustrates a structure block diagram of a processing device in a first node in one embodiment, as shown in FIG. 14. In FIG. 14, a processing device 1400 in the first node is comprised of a first receiver 1401, a first transmitter 1402 and a second receiver 1403. The first receiver 1401 comprises the transmitter/receiver 456 (comprising the antenna 460), the receiving processor 452 and the controller/processor 490 in FIG. 4 of the present application; the first transmitter 1402 comprises the transmitter/receiver 456 (comprising the antenna 460), the transmitting processor 455 and the controller/processor 490 in FIG. 4 of the present application; the second receiver 1403 comprises the transmitter/receiver 456 (comprising the antenna 460), the receiving processor 452 and the controller/processor 490 in FIG. 4 of the present application.

In Embodiment 14, the first receiver 1401 receives first information, the first information being used to determine a first time length, the first time length being larger than 0; the first transmitter 1402 transmits a first signal, time-frequency resources occupied by the first signal being used to indicate a first identifier; and the second receiver 1403 monitors a first signaling in a first time window, the first identifier being used for monitoring the first signaling; the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the first receiver 1401 receives second information and determines a first measurement value; here, the second information is used to determine a first integer set, the first integer set comprising a positive integer number of positive integer(s); X is equal to a positive integer comprised in the first integer set, the first measurement value being used to determine X from the first integer set.

In one embodiment, the second information is used to determine a first time-frequency resource set, the first time-frequency resource set comprising a positive integer number of time-frequency resource subset(s), time-frequency resources occupied by the first signal belong to a target time-frequency resource subset, the target time-frequency resource subset being a time-frequency resource subset comprised in the first time-frequency resource set; the first measurement value is used to determine the target time-frequency resource subset from the first time-frequency resource set, the first node randomly selects time-frequency resources occupied by the first signal in the target time-frequency resource subset.

In one embodiment, the first receiver 1401 receives third information; herein the third information is used to determine a third time length, the third time length being equal to a positive integral multiple of a duration of a characteristic period; the third time length is used to determine a time length of the first time window.

In one embodiment, a larger value of the first time length and the second time length is used to determine a target time length, the target time length being used to determine a length of a time interval between a start of the first time window and an end time of transmitting the first signal.

In one embodiment, the first time length is equal to one of P candidate time lengths, where P is a positive integer greater than 1, the first information is used to determine the first time length out of the P candidate time lengths; the P candidate time lengths are pre-defined, and there is a candidate time length equal to 0 among the P candidate time lengths.

In one embodiment, X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

In one embodiment, the first transmitter 1402 transmits a second signal; the second receiver 1403 receives a third signal; herein, when an end time of transmitting the second signal is earlier than a start time of receiving the third signal, the first time length is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.

### Embodiment 15

Embodiment 15 illustrates a structure block diagram of a processing device in a second node in one embodiment, as shown in FIG. 15. In FIG. 15, a processing device 1500 in the second node is comprised of a second transmitter 1501, a third receiver 1502 and a third transmitter 1503. The second transmitter 1501 comprises the transmitter/receiver 416 (comprising the antenna 460), the transmitting processor 415 and the controller/processor 440 in FIG. 4 of the present application; the third receiver 1502 comprises the transmitter/receiver 416 (comprising the antenna 420), the receiving processor 412 and the controller/processor 440 in FIG. 4 of the present application; the third transmitter 1503 comprises the transmitter/receiver 416 (comprising the antenna 460), the transmitting processor 415 and the controller/processor 440 in FIG. 4 of the present application.

In Embodiment 15, the second transmitter 1501 transmits first information, the first information being used to indicate a first time length, the first time length being larger than 0; the third receiver 1502 receives a first signal, time-frequency resources occupied by the first signal being used to determine a first identifier; and the third transmitter 1503 transmits a first signaling in a first time window, the first signaling carrying the first identifier; herein, the first signal comprises X sub-signals, where X is a positive integer greater than 1, a first symbol set is used to generate any sub-signal of the X sub-signals, the X sub-signals are respectively X repetitions of the first symbol set; X is used to determine a second time length, the second time length being larger than 0; an end time of transmitting the first signal, the first time length and the second time length are used together to determine a start of the first time window; the first signal is used for random access.

In one embodiment, the second transmitter 1501 transmits second information; here, the second information is used to indicate a first integer set, the first integer set comprising a positive integer number of positive integer(s); X is equal to a positive integer comprised in the first integer set, a measurement performed by the first node in the present application being used to determine X from the first integer set.

In one embodiment, the second transmitter 1501 transmits second information; herein, the second information is used to indicate a first integer set, the first integer set comprising a positive integer number of positive integer(s); X is equal to a positive integer comprised in the first integer set, a measurement performed by the first node in the present application being used to determine X from the first integer set; the second information is used to indicate a first time-frequency resource set, the first time-frequency resource set comprising a positive integer number of time-frequency resource subset(s), time-frequency resources occupied by the first signal belong to a target time-frequency resource subset, the target time-frequency resource subset being a time-frequency resource subset comprised in the first time-frequency resource set; the measurement performed by the first node in the present application is used to determine the target time-frequency resource subset from the first time-frequency resource set, the first node in the present application randomly selects time-frequency resources occupied by the first signal in the target time-frequency resource subset.

In one embodiment, the second transmitter 1501 transmits third information; herein the third information is used to determine a third time length, the third time length being equal to a positive integral multiple of a duration of a characteristic period; the third time length is used to determine a time length of the first time window.

In one embodiment, a larger value of the first time length and the second time length is used to determine a target time length, the target time length being used to determine a length of a time interval between a start of the first time window and an end time of transmitting the first signal.

In one embodiment, the first time length is equal to one of P candidate time lengths, where P is a positive integer greater than 1, the first information is used to indicate the first time length out of the P candidate time lengths; the P candidate time lengths are pre-defined, and there is a candidate time length equal to 0 among the P candidate time lengths.

In one embodiment, X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

In one embodiment, the third receiver 1502 receives a second signal; the third transmitter 1503 transmits a third signal; herein, when an end time of transmitting the second signal is earlier than a start time of receiving the third signal, the first time length is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.

The ordinary skill in the art may understand that all or part of steps in the above method may be implemented by instructing related hardware through a program. The program may be stored in a computer readable storage medium, for example Read-Only-Memory (ROM), hard disk or compact disc, etc.

Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node or the second node, or UE or terminal includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), relay satellite, satellite base station, airborne base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, which receives first information, the first information being used to determine a first time length, the first time length being larger than 0, and the first time length being dependent on Ephemeris of a transmitter for the first information;
a first transmitter, which transmits a first signal, time-frequency resources occupied by the first signal being used to indicate a first identifier; and
a second receiver, which monitors a first signaling in a first time window, the first identifier being used for monitoring the first signaling, the first time window being comprised of a positive integer number of Physical Downlink Control Channel (PDCCH) Period(s);
wherein the first signal comprises X sub-signals, where X is a positive integer greater than 1, a first symbol set is used to generate any sub-signal of the X sub-signals, the X sub-signals are respectively X repetitions of the first symbol set, the first symbol set comprising a cyclic prefix and multiple same symbols; X is used to determine a second time length, the second time length being larger than 0, the first time length is expressed in a number of sub-frames while the second time length is expressed in a number of sub-frames; the first time length and the second time length are used together to calculate a time interval length between a start of the first time window and an end time of transmitting the first signal; the first signal is used for random access.

2. The first node according to claim 1, wherein the first receiver receives second information and determines a first measurement value; where the second information is used to determine a first integer set, the first integer set comprising a positive integer number of positive integer(s); X is equal to a positive integer comprised in the first integer set, the first measurement value being used to determine X from the first integer set.

3. The first node according to claim 2, wherein the second information is used to determine a first time-frequency resource set, the first time-frequency resource set comprising a positive integer number of time-frequency resource subset(s), time-frequency resources occupied by the first signal belong to a target time-frequency resource subset, the target time-frequency resource subset being a time-frequency resource subset comprised in the first time-frequency resource set; the first measurement value is used to determine the target time-frequency resource subset from the first time-frequency resource set, the first node randomly selects time-frequency resources occupied by the first signal in the target time-frequency resource subset.

4. The first node according to claim 2, wherein W Enhanced Coverage Levels respectively correspond to W positive integers in the first integer set, where W is a positive integer; an Enhanced Coverage Level of the first node is one of the W Enhanced Coverage Levels, the first measurement value is used to determine the Enhanced Coverage Level of the first node out of the W Enhanced Coverage Levels, X being equal to a positive integer corresponding to the Enhanced Coverage Level of the first node in the first integer set.

5. The first node according to claim 1, wherein the first receiver receives third information; wherein the third information is used to determine a third time length, the third time length being equal to a positive integral multiple of a duration of a characteristic period, the characteristic period being either pre-defined or configurable; a smaller value of the third time length and a first threshold is equal to a time length of the first time window, the first threshold being related to a duplex-mode of a Band where a carrier to which the first signal belongs in frequency domain is present.

6. The first node according to claim 1, wherein X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

7. The first node according to claim 1, wherein the first transmitter transmits a second signal; the second receiver receives a third signal; wherein when an end time of transmitting the second signal is earlier than a start time of receiving the third signal, the first time length is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.

8. A second node for wireless communications, comprising:
a second transmitter, which transmits first information, the first information being used to determine a first time length, the first time length being larger than 0, and the first time length being dependent on Ephemeris of a transmitter for the first information;
a third receiver, which receives a first signal, time-frequency resources occupied by the first signal being used to indicate a first identifier; and
a third transmitter, which transmits a first signaling in a first time window, the first signaling carrying the first identifier, the first time window being comprised of a positive integer number of Physical Downlink Control Channel (PDCCH) Period(s);
wherein the first signal comprises X sub-signals, where X is a positive integer greater than 1, a first symbol set is used to generate any sub-signal of the X sub-signals, the X sub-signals are respectively X repetitions of the first symbol set, the first symbol set comprising a cyclic prefix and multiple same symbols; X is used to determine a second time length, the second time length being larger than 0, the first time length is expressed in a number of sub-frames while the second time length is expressed in a number of sub-frames; the first time length and the second time length are used together to calculate a time interval length between a start of the first time window and an end time of transmitting the first signal; the first signal is used for random access.

9. The second node according to claim 8, wherein the second transmitter transmits second information; wherein the second information is used to indicate a first integer set, the first integer set comprising a positive integer number of positive integer(s); W Enhanced Coverage Levels respectively correspond to W positive integers in the first integer set, where W is a positive integer greater than 1; an Enhanced Coverage Level of a transmitter for the first signal is one of the W Enhanced Coverage Levels, a measurement performed by the transmitter for the first signal is used to determine the Enhanced Coverage Level of the transmitter for the first signal out of the W Enhanced Coverage Levels, X being equal to a positive integer corresponding to the Enhanced Coverage Level of the transmitter for the first signal in the first integer set.

10. The second node according to claim 9, wherein the second information is used to indicate a first time-frequency resource set, the first time-frequency resource set comprising a positive integer number of time-frequency resource subset(s), time-frequency resources occupied by the first signal belong to a target time-frequency resource subset, the target time-frequency resource subset being a time-frequency resource subset comprised in the first time-frequency resource set; a measurement performed by a transmitter for the first signal is used to determine the target time-frequency resource subset from the first time-frequency resource set, the transmitter for the first signal randomly selects time-frequency resources occupied by the first signal in the target time-frequency resource subset.

11. The second node according to claim 8, wherein the second transmitter transmits third information; wherein the third information is used to determine a third time length, the third time length being equal to a positive integral multiple of a duration of a characteristic period, the characteristic period being either pre-defined or configurable; a smaller value of the third time length and a first threshold is equal to a time length of the first time window, the first threshold being related to a duplex-mode of a Band where a carrier to which the first signal belongs in frequency domain is present.

12. The second node according to claim 8, wherein X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

13. The second node according to claim 8, wherein the third receiver receives a second signal; the third transmitter transmits a third signal; wherein when an end time of transmitting the second signal is earlier than a start time of receiving the third signal, the first time length is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.

14. A method in a first node for wireless communications, comprising:
receiving first information, the first information being used to determine a first time length, the first time length being larger than 0, and the first time length being dependent on Ephemeris of a transmitter for the first information;
transmitting a first signal, time-frequency resources occupied by the first signal being used to indicate a first identifier; and
monitoring a first signaling in a first time window, the first identifier being used for monitoring the first signaling, the first time window being comprised of a positive integer number of Physical Downlink Control Channel (PDCCH) Period(s);
wherein the first signal comprises X sub-signals, where X is a positive integer greater than 1, a first symbol set is used to generate any sub-signal of the X sub-signals, the X sub-signals are respectively X repetitions of the first symbol set, the first symbol set comprising a cyclic prefix and multiple same symbols; X is used to determine a second time length, the second time length being larger than 0, the first time length is expressed in a number of sub-frames while the second time length is expressed in a number of sub-frames; the first time length and the second time length are used together to calculate a time interval length between a start of the first time window and an end time of transmitting the first signal; the first signal is used for random access.

15. The method in the first node according to claim 14, comprising:
receiving second information and determining a first measurement value;
where the second information is used to determine a first integer set, the first integer set comprising a positive integer number of positive integer(s); X is equal to a positive integer comprised in the first integer set, the first measurement value being used to determine X from the first integer set.

16. The method in the first node according to claim 15, wherein the second information is used to determine a first time-frequency resource set, the first time-frequency resource set comprising a positive integer number of time-frequency resource subset(s), time-frequency resources occupied by the first signal belong to a target time-frequency resource subset, the target time-frequency resource subset being a time-frequency resource subset comprised in the first time-frequency resource set; the first measurement value is used to determine the target time-frequency resource subset from the first time-frequency resource set, the first node randomly selects time-frequency resources occupied by the first signal in the target time-frequency resource subset.

17. The method in the first node according to claim 15, wherein W Enhanced Coverage Levels respectively correspond to W positive integers in the first integer set, where W is a positive integer; an Enhanced Coverage Level of the first node is one of the W Enhanced Coverage Levels, the first measurement value is used to determine the Enhanced Coverage Level of the first node out of the W Enhanced Coverage Levels, X being equal to a positive integer corresponding to the Enhanced Coverage Level of the first node in the first integer set.

18. The method in the first node according to claim 14, comprising:
receiving third information;
wherein the third information is used to determine a third time length, the third time length being equal to a positive integral multiple of a duration of a characteristic period, the characteristic period being either pre-defined or configurable; a smaller value of the third time length and a first threshold is equal to a time length of the first time window, the first threshold being related to a duplex-mode of a Band where a carrier to which the first signal belongs in frequency domain is present.

19. The method in the first node according to claim 14, wherein X belongs to a first value range, the first value range being a candidate value range among M candidate value ranges, where M is a positive integer greater than 1; a format of a preamble sequence carried by the first signal is used to determine the M candidate value ranges, the M candidate value ranges respectively corresponding to M candidate time lengths, the second time length is equal to a candidate time length corresponding to the first value range among the M candidate time lengths.

20. The method in the first node according to claim 14, comprising:
transmitting a second signal; and
receiving a third signal;
wherein when an end time of transmitting the second signal is earlier than a start time of receiving the third signal, the first time length is used to determine a time interval length between the end time of transmitting the second signal and the start time of receiving the third signal; when a start time of transmitting the second signal is later than an end time of receiving the third signal, the first time length is used to determine a time interval length between the end time of receiving the third signal and the start time of transmitting the second signal.
